(19) United States
(12) Patent Application Publication
(10) Pub. No.: US 2016/0311410 A1
(43) Pub. Date: Oct. 27, 2016

(54) VEHICLE REFUELING SYSTEM AND METHOD USING FUEL SENSORS, GLOBAL POSITIONING SYSTEM SENSORS, WIRELESS ANTENNAS, AND ELECTRONIC ALARM AND FUEL LOCK CONTROLS

(71) Applicant: WeFuel, Inc., San Jose, CA (US)

(72) Inventors: Alejandro Donzis, San Jose, CA (US); Juan Pablo Freijo, San Jose, CA (US)

(21) Appl. No.: 15/140,338

(22) Filed: Apr. 27, 2016

Related U.S. Application Data
(60) Provisional application No. 62/153,411, filed on Apr. 27, 2015.

(51) Int. Cl. B60S 5/02; E05B 83/34; G01S 19/13; G07C 5/08; G01F 23/00; G06Q 10/10; G06Q 50/30; G06Q 30/02; H04W 4/02; B60R 25/24; B60K 15/05

(52) U.S. Cl. CPC B60S 5/02; B60R 25/24; E05B 83/34; G01S 19/13; G07C 5/0808; B60K 15/05; G06Q 10/1097; G06Q 50/30; G06Q 30/0283; H04W 4/023; G01F 23/0007; B60K 2015/0561; B60K 2015/03203

(57) ABSTRACT

A vehicle refueling system provides for fuel delivery to, and refueling of, vehicles at their location when their fuel level falls below threshold values or based upon a scheduled delivery. A fuel level sensor, and one or more location sensors (e.g. GPS), are coupled via a computer system and wireless antenna to provide fuel level and position information to a fuel delivery system via a wireless communication network and to trigger fuel delivery and vehicle refueling at the vehicle's location. A vehicle processor system (VPS), and which may include an external computing resource ‘plug-in’ to an on-board diagnostic (OBD) port, performs or wirelessly communicates information associated with at least one of fuel level sensing, location determination, and electronic fuel door unlocking and/or alarm deactivation, such that the vehicle may be refueled at its location without requiring physical presence at the location by the user (e.g. vehicle owner).

### CROSS-REFERENCE TO RELATED APPLICATIONS

This application claims the benefit of priority to U.S. Provisional Patent Application No. 62/153,411, filed Apr. 27, 2015. The aforementioned priority application is hereby incorporated by reference in its respective entirety.

### TECHNICAL FIELD

This disclosure relates to systems and methods for refueling vehicles at their locations, including in certain particular aspects using global positioning system (GPS) sensors, wireless antennas and associated networked communications, wireless alarm and fuel lock controls, and fuel sensors.

### BRIEF DESCRIPTION OF THE DRAWINGS

FIG. 1 shows a schematic diagram of a vehicle refueling system according to one example of this disclosure.

FIG. 2 shows a schematic diagram of another vehicle refueling system according to another example of this disclosure, and which incorporates in part the system shown in FIG. 1.

FIG. 3 shows a schematic diagram of another aspect of a vehicle refueling system according to another example of this disclosure.

FIG. 4 shows a flow diagram of a method aspect according to another example of this disclosure.

FIG. 5 shows a flowchart for a fuel delivery method according to another example of this disclosure.

FIG. 6 shows a flowchart for another fuel delivery method according to another example of this disclosure.

FIG. 7 shows a flowchart for another fuel delivery method according to another example of this disclosure, and which at least in part determines refueling parameters.

FIG. 8 shows a flowchart for another fuel delivery method according to another example of this disclosure.

FIG. 9 shows a flowchart for another fuel delivery method according to another example of this disclosure.

FIG. 10 shows a flowchart for another fuel delivery method according to another example of this disclosure.

FIG. 11 shows a schematic diagram for a GPS tracking system that can estimate delays and schedules for fuel delivery, according to still another aspect of this disclosure.

FIG. 12 shows a schematic diagram that illustrates certain components suitable for use according to various aspects of this disclosure.

FIG. 13 shows a schematic diagram of interactive, cooperating components, including a user interface, according to further aspects of this disclosure.

### DETAILED DESCRIPTION

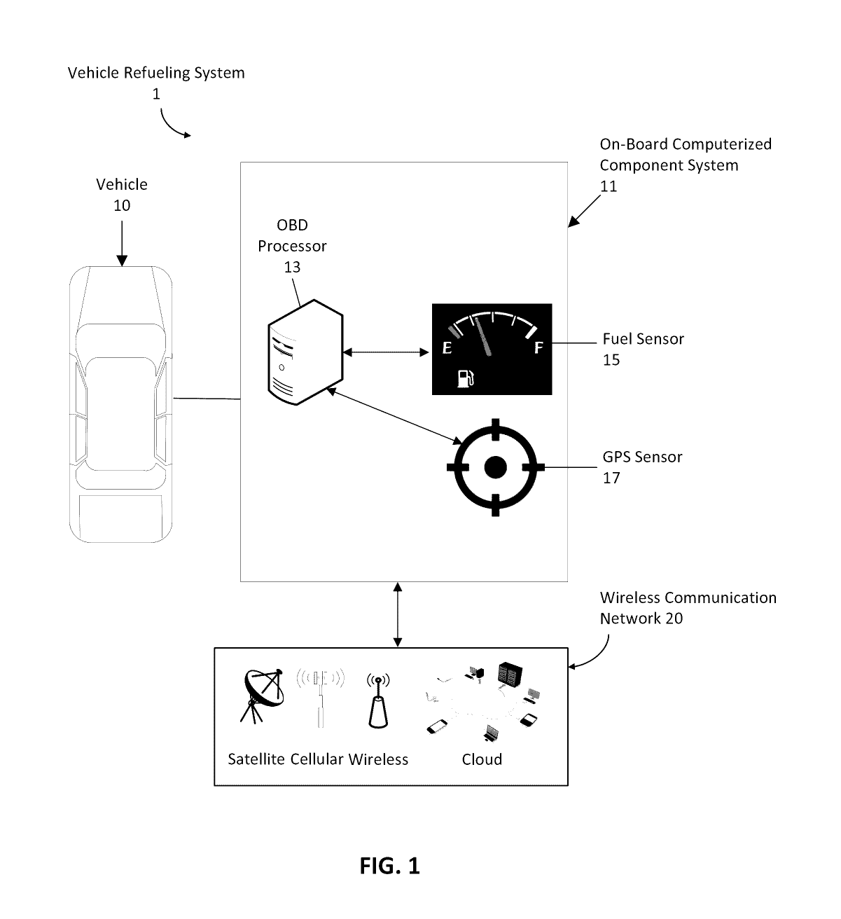

According to one aspect of this disclosure shown in FIG. 1, a vehicle refueling system 1 is provided and which includes a computerized vehicle 10 with a computerized on-board diagnostic or “OBD” system 11 coupled to a wireless communication network 20. OBD system 11 includes at least one OBD computer processor 13 coupled to a fuel level sensor 15 (represented by an exemplary fuel gauge for visual illustration purposes) and also to a global positioning system (GPS) sensor 17. Fuel sensor 15 is configured to measure a fuel level in a fuel reservoir, such as for example fuel tank (not shown), for vehicle 10. GPS sensor 17 is configured to at least in part determine the location of vehicle 10 via GPS coordinates. While such a GPS sensor and coordinate basis for location identification is considered a highly beneficial embodiment, other position or location sensor or identification approaches may also be employed in other embodiments. The OBD processor 13 may be coupled to the respective sensors 15 and 17 directly, or indirectly (e.g. via intervening circuitry, or other processor or memory resource storing information measured by the respective sensors and then retrieved by OBD processor 13). The OBD system 11 is configured and operable to transmit a diagnostic information packet, comprising at least the vehicle location and/or the fuel level of vehicle 10, via a wireless communication network 20.

As further developed among the further embodiments elsewhere herein this disclosure, this vehicle refueling system 1 is also configured to determine when the fuel level measured by the fuel sensor 15 is below a threshold value, and to coordinate with and trigger a fuel delivery provider to deliver fuel to the vehicle at the vehicle location identified in the diagnostic information packet, and for subsequent use by vehicle 10.

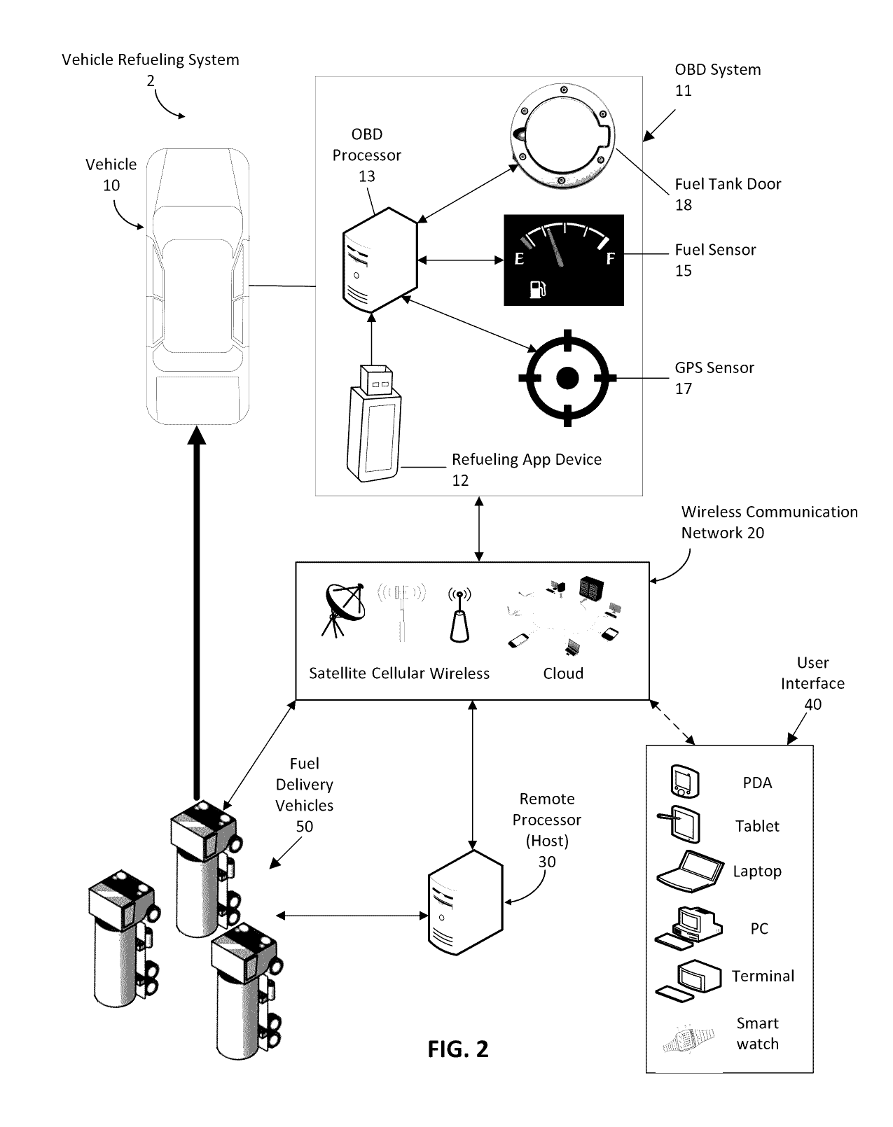

Vehicle refueling system 2 shown in FIG. 2 includes similar component aspects as system 1 shown in FIG. 1. The illustrated embodiment of FIG. 2 also shows, however, at least one remote processor 30, located remotely at a different location than the vehicle location. Processor 30 is provided in a configuration that is operable to receive the diagnostic information packet transmitted by OBD system 11, either directly or indirectly (e.g. in downstream communication from another receiver system) via the wireless communication network 20. Following such receipt of the diagnostic information packet from vehicle 10, a fuel delivery vehicle 50 is then dispatched to the vehicle location to refuel the vehicle 10. This dispatch may be triggered by remote processor 30, such as also via wireless communication network 20, or by another communication network or path. Or, other communication approaches may also be suitably applied for such purpose (e.g. conventional radio or other form of dispatching vehicles from a fleet to various locations of fuel delivery need).

As also shown in FIG. 2, a user interface 40 may also be provided in a configuration that is also operable to couple to the wireless communication network 20, and to also receive the diagnostic information packet sent by the vehicle's OBD system 11. Such user interface 40 may comprise a variety of different types of computer devices, such as for example a cellular phone or PDA, tablet, laptop, personal computer (PC), terminal computer, or wearable computing and/or communication device (and as elsewhere herein described).

The OBD processor 13 is configured to operate according to a list of instructions stored on a computer readable medium. This may be provided imbedded within the architecture of OBD processor 13, or another peripheral storage medium provided therewith. According to still another embodiment, a separate refueling app device 12 may be provided for detachable coupling with the OBD processor 13, such as for example at an OBD port that may be provided for connectivity to the OBD processor 13. Various types of such connections can be suitable for such purpose, including for example USB or other form of detachable memory or other peripheral resource computer coupling. Such refueling app device 12 may have instructions stored therein for performing the various operations contemplated among the various embodiments described herein at the OBD system 11 level of the hosted environment. Such refueling app device 12 may also include other functionality and related architecture, including for example a wireless antenna and related interface (e.g. transmit/receive) capabilities, including for example global system for mobile communications (GSM), BluetoothTM (for example using short-wavelength ultra-high frequency or “UHF” radio waves, e.g. in the ISM band from 2.4 to 2.485 GHz, and/or as may be described under the Bluetooth Special Interest Group or “SIG” standards, and/or as may be described by Institute of Electrical and Electronics Engineers or “IEEE” standards, e.g. IEEE 802.15.1), Wi-Fi (e.g. based on one of the 802.11 standards developed by the IEEE and/or as adopted by the “Wi-Fi Alliance”), or other form of suitable communication platform (and as the foregoing would also apply to other wireless communications referenced elsewhere herein). In one regard, such configuration and functionality for refueling app device 12 may provide a wireless communication platform between app device 12 and the OBD processor 13, versus for example direct OBD port access via detachable connection (e.g. if a particular OBD processor does not provide for such port access, or to avoid and overcome any connection interface compatibility requirements of such direct connection). In another regard, similar to other embodiments elsewhere herein described, this wireless connectivity via the app device 12 may be connected and communicate directly to the wireless communication network 20, and thereby to remote processor 30, and/or to a personal mobile computer providing the user interface 40.

In one particular beneficial embodiment, for illustration, the environment according to the present embodiments is achieved, at the vehicle's user level, by providing (a) a detachable refueling app device 12, configured to connect to the OBD port or otherwise communicate with the OBD processor 13 and thus manage the information acquisition and transmission from OBD system 11, and (b) a downloadable thin client ‘app’ for a personal mobile computing device providing the user interface 40.

According to certain further embodiments, multiple approaches are contemplated for performing the determination that the fuel level is below the threshold level. In one such embodiment, this determination may be done, for example, by the OBD processor 13 itself. In one beneficial mode of this embodiment, this determination may be used to trigger the diagnostic information packet transmission with the vehicle location information. In another embodiment, this determination may be done by another external processor on the receiving end of the diagnostic information packet via the wireless communication network 20. More specifically, for example but without limitation, the diagnostic information packet may include both the vehicle location and the measured fuel level. Further to this example, an external processor receiving the diagnostic information packet via the wireless communication network 20 may be configured to make the determination based on the fuel level in the diagnostic information packet, and also to then initiate the fuel delivery to the vehicle location also provided in the diagnostic information packet.

In still a further embodiment, the fuel level measurement information used for making the level determination, and/or the initial transmission of the diagnostic information packet, may be uncoupled from a different wireless transmission of the vehicle location that is used at the time that fuel delivery is actually performed within the system environment. In one such example, an initial trigger signal is transmitted when the fuel level determination is made. In one mode, another subsequent diagnostic information packet transmission from the OBD system 11 provides the vehicle location at a separate later time and which is used for the fuel delivery. In another mode, inputs into user interface 40 are used to identify or trigger the vehicle location. This can occur, for example, by user inputs providing a time and location for fuel delivery (and/or range of such options). Or, in another example, this can occur by communicating via the user interface 40, in response to the input, to the OBD system 11 to transmit a diagnostic information packet with the vehicle location at that time (or at another time identified via the communicated input). For example, an input can include a calendar entry with a scheduled window planned for refueling. Upon occurrence of that scheduled time window, the vehicle location is identified and communicated for fuel delivery (either de novo to the fuel delivery system, or to confirm location already identified via the user input according to the plan). Such calendar entry may be made within a calendaring functionality provided within the system environment itself, or within another separate calendar environment (from which such entry is identified and linked to the system environment for purposes herein described).

Certain such embodiments and examples as described above illustrate certain (though not all) further aspects of this disclosure, in which the user interface 40 is configured to transmit the signal and/or information which triggers the fuel delivery. In one still further example of such aspects, a user can determine via conventional means (e.g. standard fuel gauge) that the fuel level is below a threshold, and provide an input via the user interface 40 to trigger the fuel delivery. The vehicle location in such implementations may still be identified by the GPS sensor of the vehicle and sent as diagnostic information packet for fuel delivery as described in other embodiments above. Or, the vehicle location may be identified also by the user interface 40 inputs (or GPS sensor of that user device, to the extent it may be co-located with the vehicle when transmitted). Other calendar scheduling approaches elsewhere described herein may also be integrated into such approaches.

The coupling of remote processor 30, and/or user interface 40, to wireless communication network 20 may be via a direct connection, e.g. via a wireless receiver connected to network 20. Or, such coupling may be indirect by including other communication channels located downstream of the wireless communication network 20 on which the diagnostic information packet is originally transmitted and then received. This may include, for example, wired connections, and/or other additional wireless communications networks that re-transmit the diagnostic information packet previously received upstream of the information flow.

It is thus also appreciated that the coordinated flow of the information provided in the diagnostic information packet, from its original transmission ultimately to the remote processor 30 to trigger the fuel delivery, may also take a number of different specific forms.

For example, the diagnostic information packet may be transmitted in parallel fashion downstream to each of the remote processor 30 and user interface 40. Such configuration may, for example, allow for automated triggering of the refueling operation but while also providing notice to the user or possessor of the vehicle that a refueling process has been triggered (and/or opportunity to provide inputs via the user interface 40 to coordinate for such fuel delivery, as elsewhere herein described).

In another example, the diagnostic information packet is first transmitted to the user interface 40, but not the remote processor 30. This may allow, for example, some control by the user to first receive notice of the information, but then to communicate a signal from the user interface 40 to the remote processor 30 in order to trigger the fuel delivery vehicle to deliver the fuel to the vehicle's location.

In still another example, including as also elsewhere herein described, each of the remote processor 30 and user interface 40 may both receive the initially transmitted diagnostic information packet. A system according to this example may be configured to require and provide for confirmation from the user interface 40 before actually delivering the fuel to the vehicle, and/or other coordination. It is generally appreciated that an initially transmitted diagnostic information packet may merely initiate a process for delivering fuel to the vehicle, but with certain other steps and coordination still required to actually confirm and/or perform such delivery. For example, the user may drive the car from its original location at the time of the initial triggering packet's transmission to another location prior to the time fuel delivery is conducted. According to one mode under this example, the GPS coordinates of the vehicle location may be further monitored (and further transmitted), such that the fuel delivery is coordinated to a particular location at a particular time (and which location may vary over time). In other further modes, the system may be configured to receive inputs from the user interface 40 to assist in such smooth coordination for location and timing.

According to another example, for purpose of illustration, upon the user receiving notice that the refueling trigger has been transmitted, the user may then input information to assist in the fuel delivery, e.g. indicated time windows and locations where the car will be parked, such as for example when the car will be at home, work, or other parked location. In certain circumstances and applications of the various aspects contemplated herein, automated GPS monitoring of the vehicle's location (and communicating this when the fuel level is low, or at the time window for pre-scheduled fuel delivery) may alone be sufficient to automate fuel delivery to the car without requiring user involvement, according to one highly desirable embodiment. However, significant time and resource may also be wasted if the user drives the vehicle away from its original location after a fuel delivery vehicle 50 is already dispatched to that location.

According to yet another example, such notice to the user interface 40 may also allow the user and/or the host and/or the delivery provider to unlock or otherwise open the gas tank door 18 to enable refueling, and/or deactivate a car alarm (not shown) during the anticipated refueling time window—including in particular without requiring the user to be co-located with the vehicle for such unlocking or deactivating. While such examples may be desirable for certain users and situations, it is also contemplated that such coordinated operations may also be controlled automatically by the OBD processor 13 coupled to these components in the car, or via the remote processor 30 communicating through the wireless communication network 20 and to the components via the vehicle's own computer system(s), according to still further aspects of this disclosure. Accordingly, it is also thus contemplated that certain information or parameters stored in a computer accessible database or other form of memory, and/or provided in the wireless communications between the user interface (and/or the user's vehicle, e.g. via its own computer processor, e.g. OBD processor 13) and remote processor 30 (and/or a processor provided at the fuel delivery system communicating with the remote processor 30, user interface, or vehicle), may include certain codes, electronic keys, or other form of information that permit electronic access and activation of such operations at the vehicle.

As one of ordinary skill would appreciate according to the foregoing, modern vehicles are often equipped with such electronically controlled fuel locks and alarms as valued security measures, and thus it is desirable to maintain that security (or at least minimizing security risks) while also nonetheless providing access to the vehicle's fuel reservoir (e.g. tank) for refueling while the vehicle's owner may not be co-located with the vehicle to themselves disable such alarm or unlock such fuel door (as contemplated among the various embodiments of this disclosure). Accordingly, such further embodiments are thus contemplated to provide such limited and temporary ability to disable such alarm, and/or unlock such fuel lock, for an authorized refueling vehicle to gain such access. In one such embodiment, for example, disable or unlock instructions may be provided as unique codes associated with a particular vehicle, such as may be identified via the vehicle identification number or “VIN”—and may be provided to or accessible by the vehicle refueling system. Such codes may then be transmitted to the vehicle's OBD or other on board processor, either via a wireless connection between a vehicle antenna and a refueling vehicle processor system (RVS) or remote processor system (RPS) providing such code instructions. In one further embodiment, this may be triggered upon determining that the refueling vehicle (RV) is co-located with the vehicle (e.g. has arrived for refueling), and which may be determined for example by various approaches herein disclosed by further embodiments (or otherwise). Moreover, a security confirmation may also be required prior to providing such access, which may be for example according to still further embodiments of this disclosure (e.g. unique code identifiers for each of the RV and vehicle to confirm authorized refueling) or as would otherwise be apparent to one of ordinary skill. Moreover, various approaches to returning the vehicle to a secured configuration (e.g. activated alarm, locked fuel lock) are also contemplated, such as for example according to other embodiments also herein described.

It is also appreciated that numerous variations of the above features may be implemented to accommodate certain electronic control systems particular to different vehicle types. For example, for some vehicles an electronically controlled fuel lock may be on a fuel door that directly covers a fuel port to the fuel reservoir (e.g. tank) and which may be directly controlled between locked/unlocked conditions via a controller of a vehicle computer processor system—and thus directly controllable by unlock or lock instructions transmitted to the controller. In other vehicles, however, such a fuel door may be unlocked by an actuator within the internal cabin of the vehicle (e.g. mechanical latch/lever assembly, or button actuator, which may also be either mechanical or electronic in its coupling to the fuel door lock). Thus a user requires access to the internal cabin in order to control the fuel door lock via the actuator. According to certain such vehicle arrangements, and representing still further embodiments hereunder, a cabin door that controls access to the internal cabin, and thus the fuel door actuator, is electronically unlocked via an unlock instruction and resulting controller command to a cabin door lock. Such operation thus provides user access to the fuel port by allowing access to the fuel door lock release mechanism in the cabin. In such regards, it is appreciated that the cabin door lock is essentially a fuel lock, since the difference between its unlocked and locked conditions is the difference between allowing and preventing access to the fuel reservoir (albeit via a subsequent step by the refueling operator to actuate the actuator). In this context, the cabin door can be considered a first fuel door, and the cabin door lock as a first fuel lock, while in many if not most cases there is also a second fuel door directly over the fuel port and with its second fuel lock—which again is allowed to be easily unlocked from within the cabin after unlocking the first fuel door lock.

Notwithstanding the specific approach implemented in a particular application, however, it is to be broadly appreciated that a refueling operation dispatched to vehicles not co-located with their owners/operators—as contemplated among the various aspects of this disclosure—would only be possible for the great many vehicles with such electronically controllable security measures (e.g. fuel locks and alarms) by providing such alarm deactivation and fuel door unlocking interfaces and measures.

According to still another embodiment of this disclosure, information sent in either or both directions between the remote processor 30 and user interface 40 may assist in coordinating the timing for the user to be present for the refueling, if that is desired.

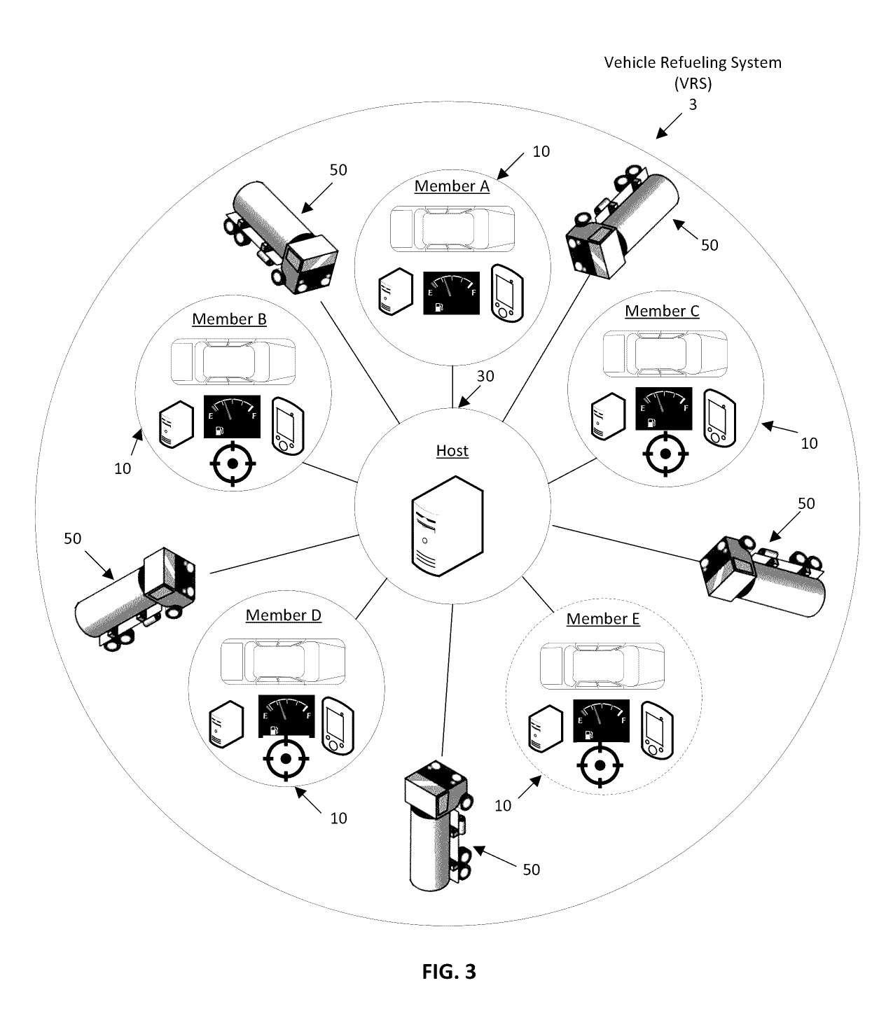

As further shown in FIG. 3, a vehicle refueling system 3 provides for a managed refueling environment including a plurality of user members A-E (which can be any number of n members) to take advantage of the various automated or partially automated refueling benefits of the previous embodiments (or other embodiments below), and with one or more fuel delivery members of the system environment representing a fleet of fuel delivery vehicles provided to cover various geographies and volumes of such member users and their respective vehicles. According to the example shown in FIG. 3, the coordination between the user members and fuel delivery members is managed through at least one central or remote processor 30. Accordingly, such system is scalable and fuel may be efficiently delivered across ultimately an unlimited geographic range of locations, across ultimately an unlimited number of member vehicles, limited only by the number and coordinated management of fuel delivery vehicles, and the resources, connectability, and bandwidth of the central processor and/or communication network. Moreover, according to a further embodiment, a location identification sensor and/or interface (e.g. GPS) is also provided with the fuel delivery vehicles 50. A unique efficiency is achieved by providing such location identification interfaces, e.g. GPS, with both the vehicle 10 requiring refueling and also the fuel delivery vehicles 50. This allows such a widely scalable, managed system environment to most appropriately deliver fuel to many vehicles at unique respective locations via the most appropriate (e.g. by their own location, and fuel reserves for delivery) fuel delivery vehicles from the fleet. In still further beneficial embodiments, such management for appropriately dispatching delivery vehicles to vehicles requiring the refueling may be achieved by the remote processor 30, or one or more other processors, based on the respective location coordinates and/or fuel needs (respectively).

A fuel delivery vehicle fleet, such as shown and described by reference to FIGS. 2-3, may be a dedicated fleet for purpose of this managed vehicle refueling system environment and respective operations, or may be provided by one or more (e.g. via a network of) contract fuel delivery providers. For example, appropriate vehicles from one or more companies may be enlisted to deliver fuel ‘on demand’ to the various user members based upon these present system and method embodiments. For example, towing and/or roadside assistance companies (e.g. Automobile Association or America or AAA), may be engaged as a contractor to deliver fuel via their vehicles to member users of this system environment. According to still further embodiments, an auction or reverse auction environment may be provided for such fuel delivery contractors to be engaged for one or more such fuel delivery operations as they are demanded by the vehicle users. For example, a user's refueling need and vehicle location may be identified within a system environment, which then hosts an environment listing the particular delivery job specifications and allowing various different contractors to ‘take the job’ or bid on the ability to do so.

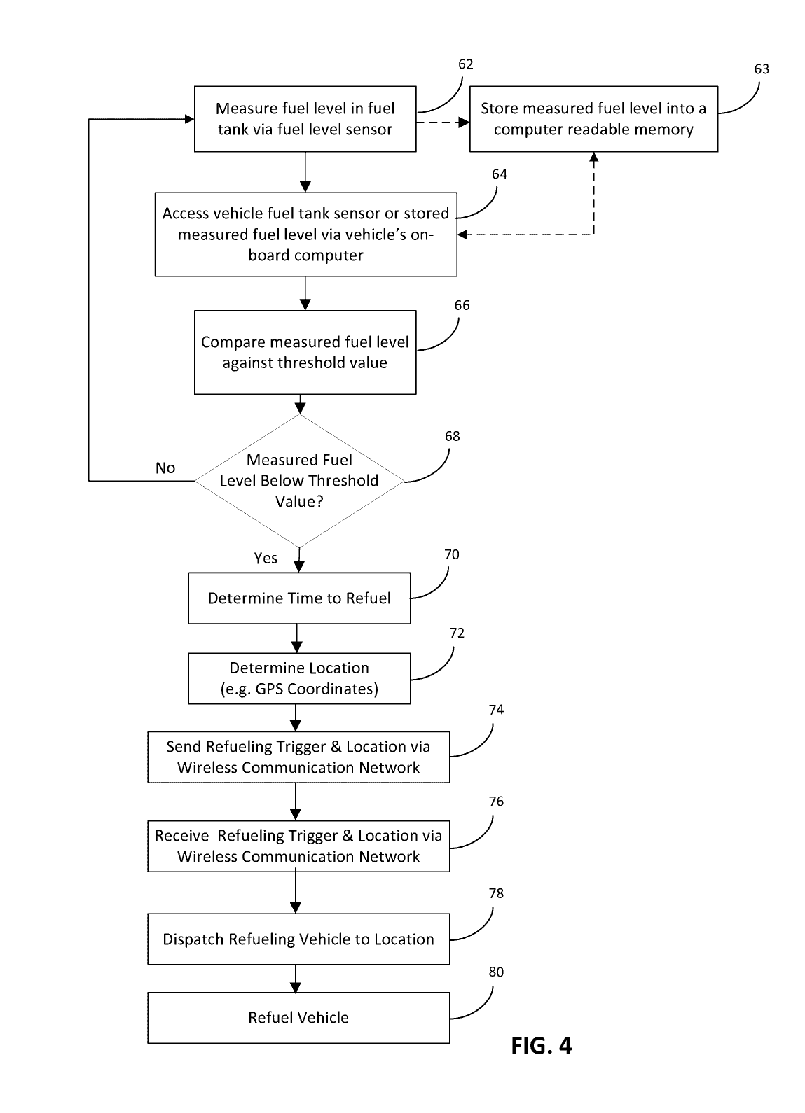

Various methods are contemplated in regards to the present system embodiments of this disclosure. One such example is shown in FIG. 4 as follows. As shown at operation 62, the fuel level in a vehicle's fuel reservoir is measured via a fuel level sensor coupled to the reservoir. As shown at operation 64, the vehicle's OBD computer processor either accesses the measurement directly via the sensor, or a record of the measurement stored in a computer readable memory. This measured fuel level is compared against a threshold value (operation 66). As shown at operation 68, if it is below the threshold value than a determination is made to refuel (operation 70), the location is also determined (e.g. via GPS coordinates)(operation 72), a refueling trigger and location is sent via a wireless communication network (operation 76), and a refueling vehicle is dispatched to the location to refuel the vehicle (operation 78 and 80). It is appreciated that the various other embodiments described above, or elsewhere herein, may also appropriate represent modifications of the method embodiment described above.

According to the foregoing, as will be readily apparent to one of ordinary skill, various aspects of this disclosure relate to a system and method for refueling vehicles. Certain such aspects relate to a system and related method for delivering fuel to, and for subsequent use by, vehicles. Without limiting the broad conventional scope of the term as known to one of ordinary skill, but for purpose of illustration, the term ‘fuel’ may comprise a wide variety of fuels suitable for powering a vehicle and/or as may otherwise be suitable for the general purpose and uses disclosed within these systems and methods disclosed herein. This will typically mean a transferrable resource that provides a source of energy (e.g. power and/or heat), and may include, for example but without limitation: gasoline, diesel, ethanol, biodiesel or other form of biofuel, natural gas, hydrogen, any other fuel, and/or any mixture or other combination of different types of fuels (e.g. gasoline mixed with ethanol). In most typically cases, such examples are characterized as fluids, and in most of those cases liquids (although gas fuels are also contemplated). In other cases, a fuel could be or at least contain certain solids. In certain further examples, a ‘fuel’ contemplated hereunder may also include an electric current or charge to the extent transferrable and storable (or convertible into a storable form) for later use in generating or providing energy or it may also include the replacement of a charge or fuel cell device (e.g. battery) used to store such current or charge.

Further to the above, and as would be apparent to one of ordinary skill, the present description's use of the term ‘reservoir’ for such fuels is considered broadly applicable for such variety of fuels. This many include, for example, a ‘fuel tank’ for fluids. Or, in another example, this may include a battery or other source of transferrable or applied energy (e.g. electrical current or charge). Accordingly, reference hereunder to fuels and associated reservoirs, ports, transfer couplers, etc. should be considered to include such breadth and applicability to these and other types of more specific implementations. Moreover, it is also contemplated that more specific references made herein to one or another type of such alternatives, (e.g. fuel ‘tank’), are applicable in other contemplated embodiments to such other alternatives (e.g. battery or other applied charge source). In still a further example, ‘refueling’ may include replacing a fuel such as gasoline, and/or may also include a recharging of a battery or other storage source of electrical charge or current. Notwithstanding these alternatives contemplated under such broad aspects, however, it is also further appreciated that many of the current embodiments enjoy certain particular benefits when applied to refueling of gasoline (or other form of combustible or fluid fuel)—e.g. stealing gasoline from vehicle fuel tanks is a particularly well known security risk.

Furthermore, fuel locks and the application of some embodiments to unlock them may also take various forms. For example, in the case of electric vehicles (EV), a fuel lock may be a controllable electrical (or software-related) feature or break in an electric circuit to prevent electrical access to a battery's charge unless ‘unlocked.’ In certain EV cases, since electrical circuits are uniquely controllable, a vehicle's stored battery charge may simply be electrically inaccessible via the vehicle port, such as for stealing that charge, other than in the applied polarity and other required electrical coupling to facilitate a recharging of that battery. In certain such cases, a fuel lock may not be required as there may be little to no security risk to protect. In many other embodiments, however, it is contemplated that such fuel locks—while they may include certain electrical actuation components—have mechanical mechanisms, such as a latch or other form of typical lock that mechanically secures a door in a closed condition, and/or a mechanical latch as an actuator to unlock the lock.

According to certain other aspects of this disclosure, such refueling aspects are further combined with the delivery of other products and/or services also to the vehicle. This may include, for example, other vehicle-related products and/or services, e.g. fluids check and/or change (e.g. oil, brake fluid, windshield wiper fluid), belt(s) check and/or change, other inspections and/or related results and/or re-conditioning (e.g. condition of tire tread, brake pads, etc.). This may also include combination delivery of other products and/or services, such as for example but without limitation those commonly found in gasoline stations' convenience stores.

Various benefits are uniquely provided by the various aspects and related embodiments, modes, and examples of this disclosure, and which address various unmet needs. For example, drivers conventionally drive their vehicles into fuel stations in order to purchase fuel for refueling their vehicles. This typically involves a decision that needs to be made by that driver regarding when, and where, to refuel. This also requires the affirmative action by and time of each such driver to refuel. At a minimum, this is a pervasively inconvenient requirement upon virtually all drivers. Even worse, this also carries incumbent risks, such as running out of fuel, and being stranded on the side of the road as a result, due to miscalculating the timing to refuel (or forgetting to monitor all together). This conventional process also often requires more driving, in order to get to refueling stations, and thus increasing the consumption of fuel.

Furthermore, in order to accommodate the conventional ‘drive to the station’ refueling environment, gas stations for example are virtually everywhere in modern industrial society. In addition to occupying an enormous volume of valuable real estate, their many in-ground tanks and other aspects are also considered environmental hazards—the monitoring, risk prevention, and/or defect remediation of which also requires significant regulatory and other resources. For example, gas stations in earthquake risk zones are subject to special regulations due to such increased risks. Various aspects herein disclosed allow for more centralization of source fuel reserves, e.g. to provide fuel to a fleet of fuel delivery vehicles. This beneficially reduces the number of required fuel tanks spread across a given populated geography, and may be centralized in areas identified for reduced risk (e.g. more remote locations away from occupied populations, away from earthquake faults or other undesirable aspects of a given location).

It is thus to be appreciated that various aspects of this disclosure overcome one or more of these (and/or other) shortcomings of such conventional refueling systems and methods.

According to certain more detailed aspects of this disclosure, in addition to measuring fuel level, other measurements may also be similarly made (and/or accessed if already made), via other respective sensors for other parameters, such as for example fuel consumption, and/or position of the vehicle. One or more sensors are used to establish when and where to refuel a car automatically. According to still other aspects of this disclosure, parameters such as location for refueling, day and/or time of refueling, etc., could be programmed into the system for a given user's vehicle so that the refueling is executed according to certain preferences. This may be done instead of, or in addition to, triggering a refueling operation based upon monitoring of such fuel level and/or location.

Still further aspects are also considered under this disclosure, either in regards to the detailed embodiments herein shown and described or otherwise, including without limitation as follows.

According to one such aspect, a method for delivering fuel to users is provided. This method involves executing a transaction for the purchase of fuel and its delivery. This may include a user selecting an address (or other form of location coordinates, e.g. GPS) where the fuel is to be delivered, and the type of fuel to be purchased. Then, fuel is delivered to such user at that location. The user may select a vehicle or vehicles, which are to be refueled. The purchasing criteria could also include the volume to be purchased, and/or the amount of vehicles to be refueled. The user (e.g. purchaser) calls the fuel delivery through a mobile app, the Internet, websites, a cellular network, or any other connection resource. The delivery may include the estimation of the delay for the delivery of fuel to arrive at the desired destination. The purchasing user according to this aspect, as may well also apply to other aspects herein disclosed, pays the amount of fuel served to the vehicle or vehicles selected. This payment may be done by credit card, debit card, cash, electronic payment methods, check, or any other generally accepted payment method at the time the transaction is executed.

According to another aspect of this disclosure, when fuel is delivered to users, the selected vehicle or vehicles may be refueled by a third person or robotic equipment so that users do not need to intervene in the process.

According to still further aspects, one or more sensors are employed to retrieve information from the vehicle or vehicles involved in a potential transaction. That information may include, among others, vehicle position, fuel tank level, and fuel consumption. In certain embodiments, such information is used to determine when and where the vehicle or vehicles will be refueled, following automatic instructions and/or preferences determined by purchasers. Certain such exemplary embodiments use sensors to gauge parameters from the vehicle, which information is retrieved through the OBD port (e.g. OBD I or OBD II) of the vehicle, or may be otherwise retrieved through other suitable approaches. The information may be transmitted to a computer or processor that determines when and where to fuel the vehicle. Additionally, certain parameters such as fuel level to refuel, day of the week to refuel or position where to refuel could be programmed so that the refueling is executed according to certain parameters predefined by the user (or by the fuel delivery system).

According to another aspect of this disclosure, a method for executing a transaction for the sale of fuel is executed. The method includes a fuel delivery provider stating a price, and offering such terms to users. Users' acceptance may be received and the transaction may be executed in consequence.

According to still a further aspect of this disclosure, fuel is delivered to users at certain pre-defined locations, such as for example parking lots of malls, plazas, hotels, homes or offices. In one such embodiment, fuel is delivered at the parking lot where users park their respective vehicles. In still a further embodiment, the fuel delivery operation is combined with a valet parking operation where users leave the vehicle or vehicles at a determined location and the vehicle is returned to them after refueling it.

In still further embodiments of the various aspects herein described, a delay for the delivery of fuel is estimated and communicated to the purchasers. In further embodiments, a scheduling system is provided whereby users schedule in advance a timeframe and location where the delivery of fuel is executed.

In additional embodiments also contemplated hereunder, users pre-pay for fuel. According to one such further embodiment, for example, if a pre-paid stock of fuel is larger than the fuel delivered in a certain refueling transaction, the excess will be held as pre-paid stock by the provider of the fuel delivery operation. Accordingly, in one such regard, users can pre-pay for fuel, purchasing a larger amount of fuel than what they will refuel when executing the transaction. This pre-payment transaction could be done even without refueling vehicles in said transaction. In that way, the pre-payment transaction enables users to fix a price for a certain amount of fuel that they or others plan to use in the future. In still further embodiments, social networking within the environment may allow multiple user members of the refueling delivery system to combine their pre-payment purchases as a consortium, with the potential to yield reduced fuel prices in the scaled bulk purchase aggregating their individual forecasted needs.

In certain further variations to the various aspects and embodiments herein described, it is also contemplated that the price may be determined by a retail index price, or could be determined by the provider of the fuel delivery operation.

The various aspects, modes, and embodiments are presented herein for purpose of illustration in terms of various parties involved as members of the hosted environment and related communications and operations conducted thereunder. This includes, for example, by reference to “users” (e.g. consumers and/or purchasers of fuel delivery operations, such as for example drivers or other vehicle owners, or parties otherwise vested with vehicle refueling). This also includes, for example, various references to fuel delivery providers, source fuel providers (who provide fuel to the fuel delivery providers), and/or one or more ‘host’ parties who possess, own, and/or control the remote server or processor that hosts a respective environment under which such other parties communicate for coordinated operations and/or related transactions. It is contemplated that certain such parties may be the same party, or different parties, depending on the particular implementation and/or circumstance. For example, for illustration but without limitation, a host party may also be the same party as a fuel delivery provider. In this situation, receipt of communicated information from users for fuel delivery needs to their respective vehicles, and delivery of that fuel to those vehicles, may be managed under the same party or entity (or under common control or other form of affiliated relationship).

The refueling system and method aspects herein described may be provided, hosted, and maintained according to a wide variety of systems and methods, as would be apparent to one of ordinary skill. However, in one particularly beneficial implementation, such as illustrated in FIGS. 1-3, the respective hosted environment is securely operated via one or more computer processors or servers. Such processors or servers will also typically interface with one or more databases, which may include multiple separate or networked databases, to support the various activities conducted within the environment. Generally, the database will include, among other things: registered member lists, and their associated membership and respective vehicle information, payment information, and certain permission levels that may also be structured into the system and associated therewith (e.g. types of service or operation contracted, type and/or price range of fuel desired, other desired combined services or operations, permissions to access vehicle without the consumer owner present, etc.). This may also include diagnostic information, such as user fuel consumption, delivery needs, driving habits, and/or other purchasing habits as accessed or transacted through the hosted environment. Such purchasing user (and fuel delivery provider) information may become valuable and leveragable for many different purposes, including broader societal or community assessments, or more customized purposes such as establishing and using user ‘profiles’ based on such information (such as, for example, for purpose of determining refueling parameters, targeted marketing and/or advertising based on such profiles).

The hosted environment according to such present aspects and embodiments will also typically provide a user interface for each of the respective members, delivered via their own respective computing devices connected to that environment. The interfacing computing devices will typically provide a user input interface (e.g. keyboard or keypad, touch screen, mouse, etc.) and a user output interface, such as a display (and may include for example touch screen display providing both input and output interface functionality). According to one highly beneficial more detailed embodiment, the environment includes a software-based application or ‘app’ that is downloadable via internet connectivity by user members. In still further beneficial embodiments, such app provides the user member access to (and interface/navigation within) the environment via a touch icon on a touch screen of a mobile computing device, such as for example a mobile phone or notepad, with wireless internet connectivity. Prior to or with download of the environment ‘app,’ members will typically subscribe to and/or register within the environment. While such subscriptions may take many different forms and requirements to suit a particular need, in some examples subscription fees may be required. In some embodiments, this may be limited to an authorized member, e.g. administrator, for a group. For example, an adult member of a family (e.g. father/husband and/or mother/wife) may have administrator privileges for an account under which children may also be members able to exercise refueling operations, but were only the administrator can change account information, settings, pricing and/or payment authorizations, social networking links through the environment, etc. Moreover, other agreements may be required to certain policies and procedures such as with respect to ensuring privacy, security, appropriate content and other practices in the respective conduct within the environment.

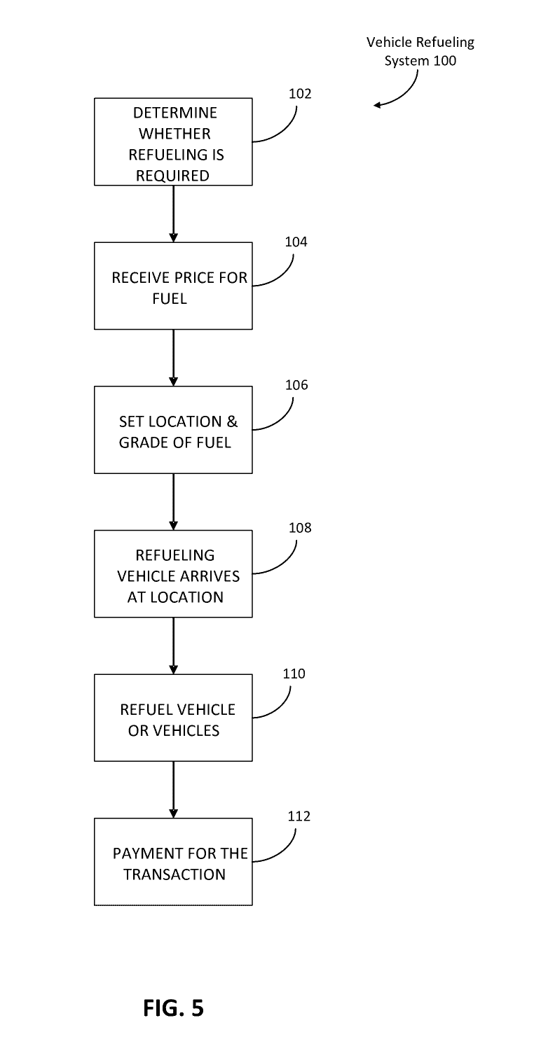

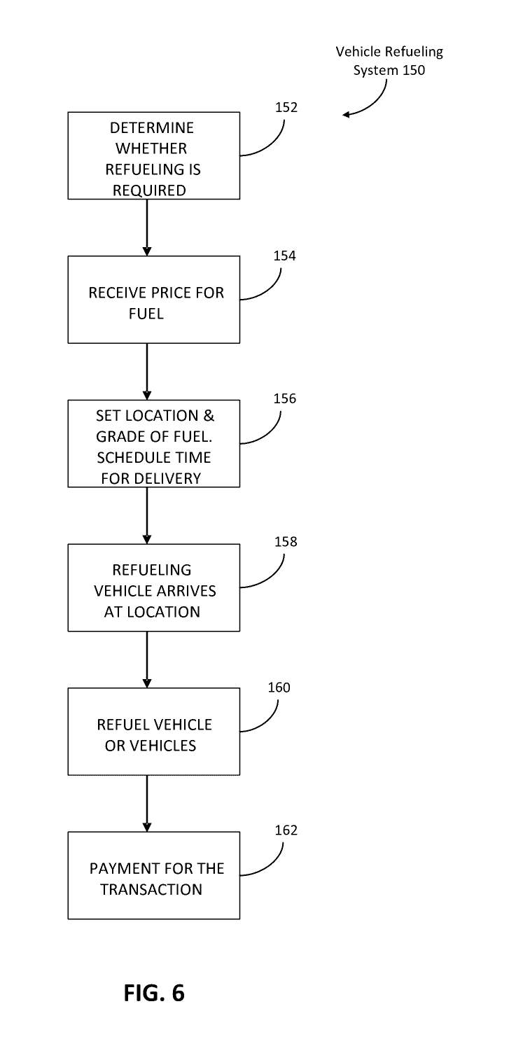

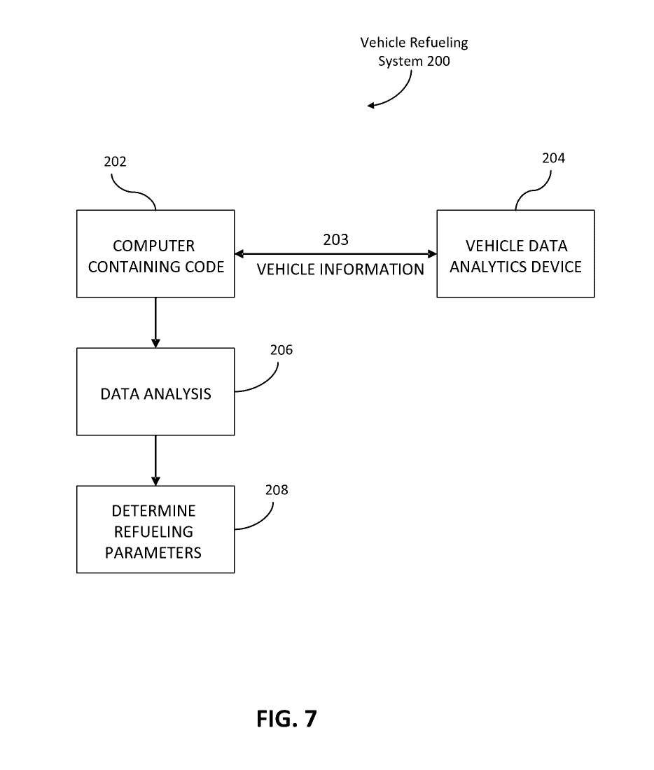

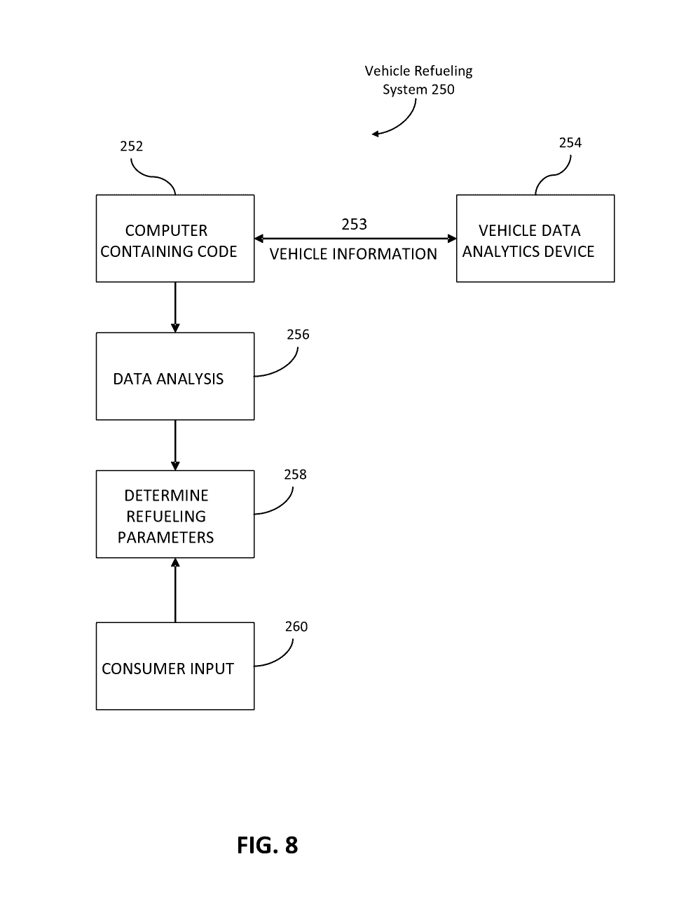

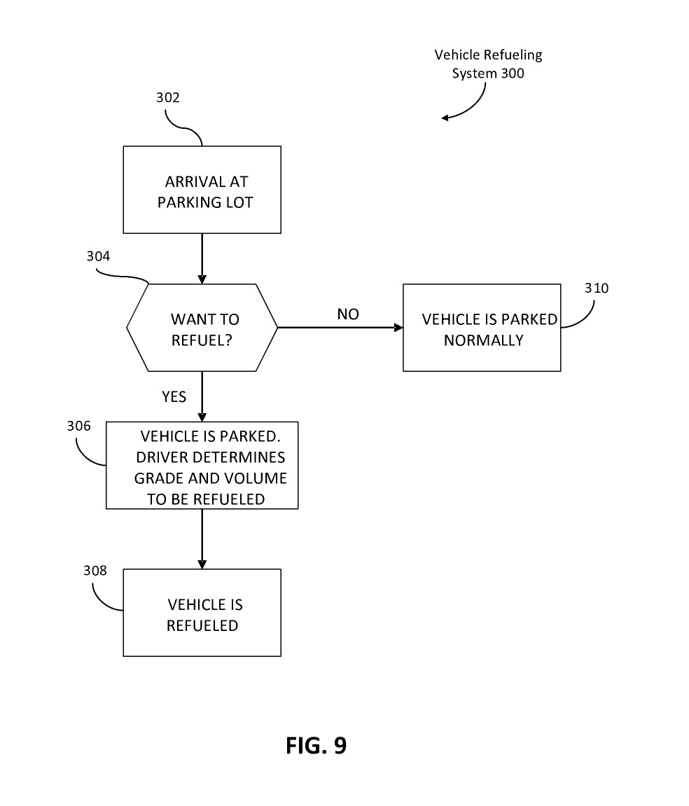

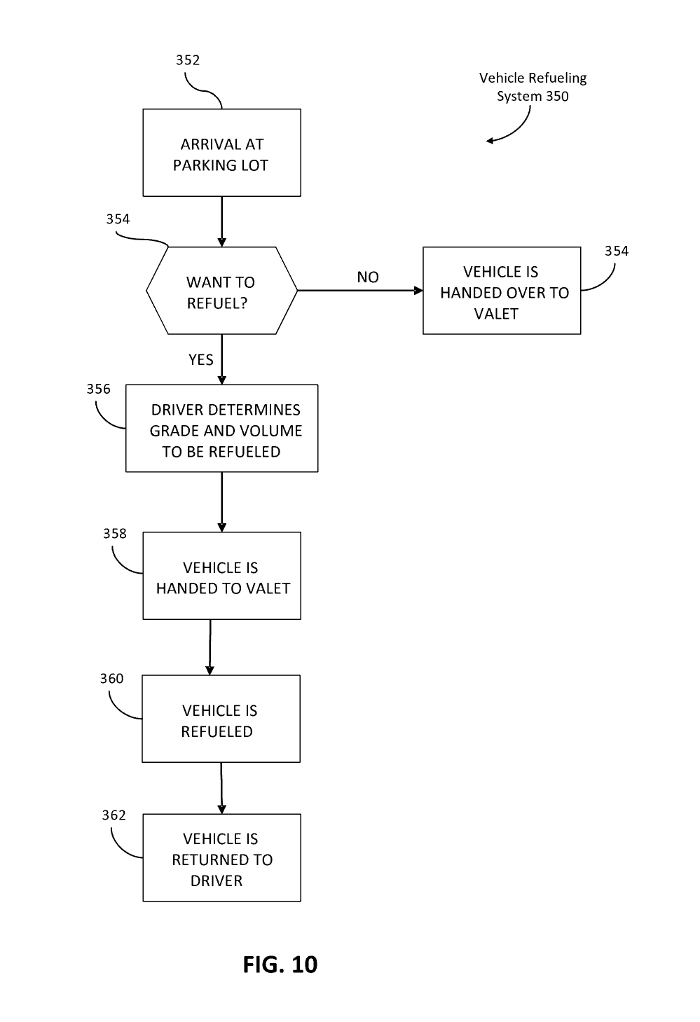

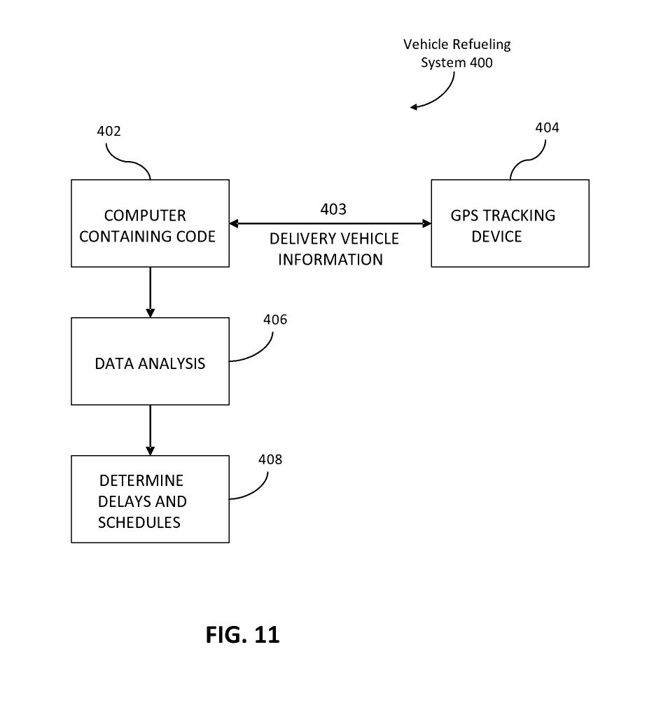

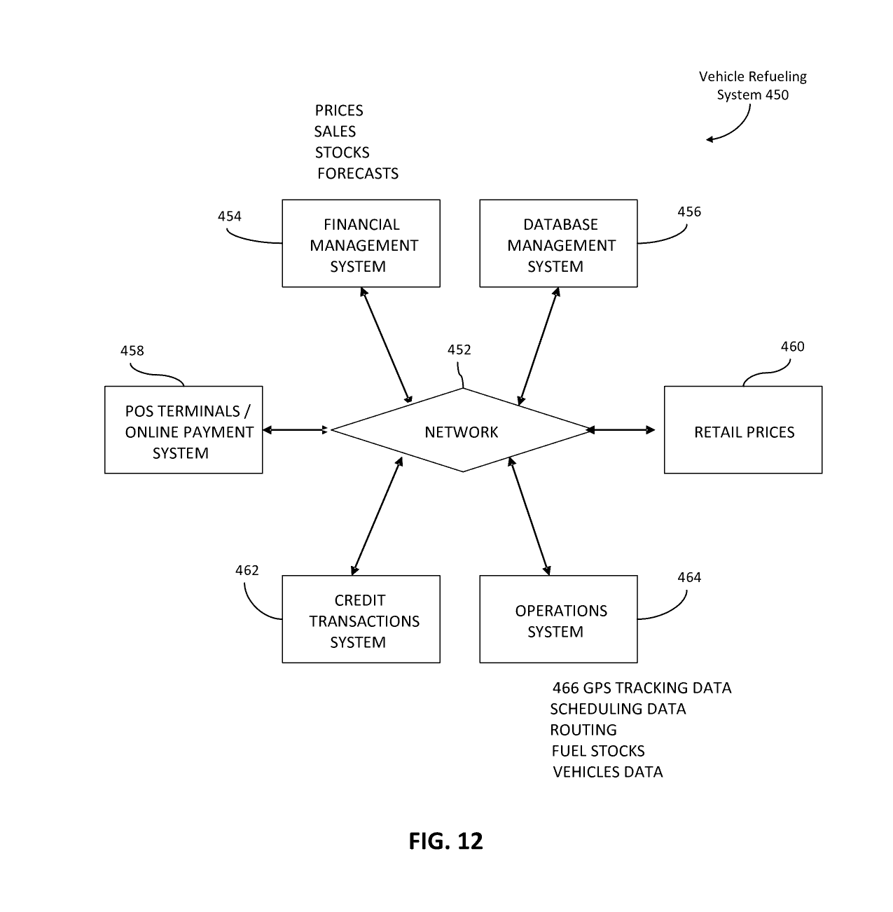

It is appreciated that many methods are herein contemplated by the present embodiments, including for example as described in FIGS. 4-12.

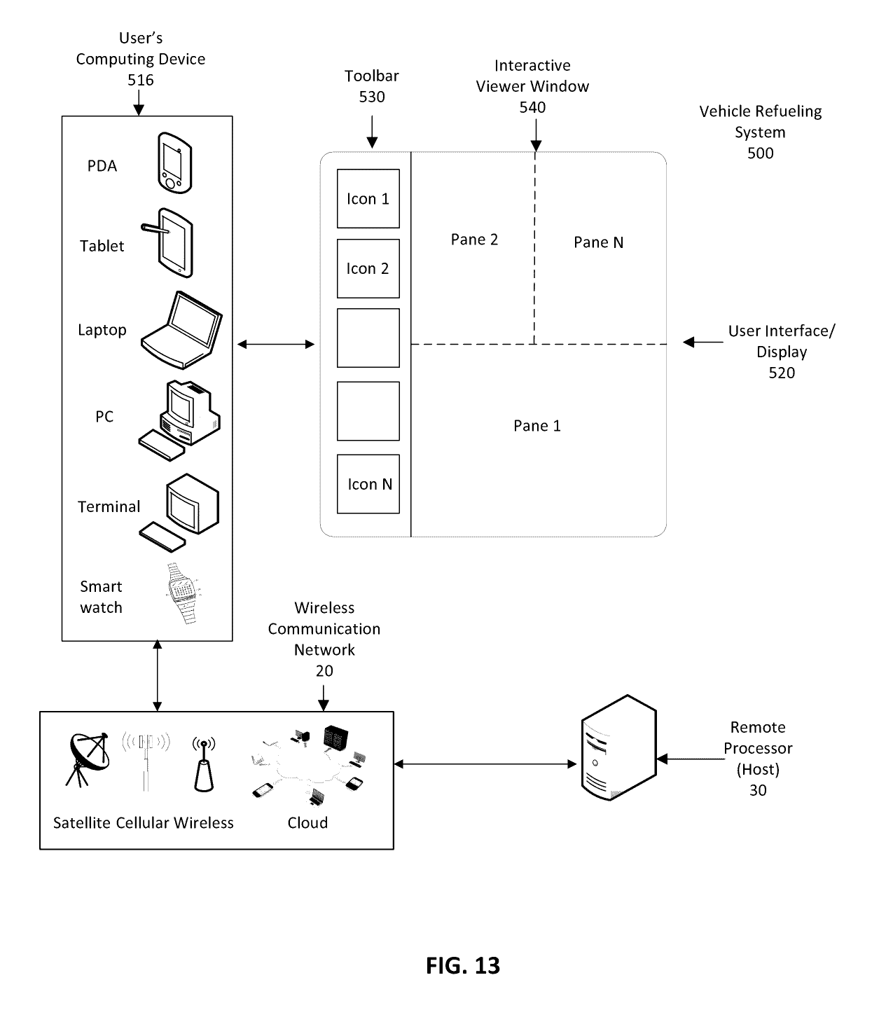

FIG. 13 (reference to wireless communication network 20 is missing) illustrates certain further examples of a system architecture for providing and supporting a vehicle refueling system 500, and considered applicable under the various embodiments elsewhere herein described. More specifically, one or more servers or processors, such as remote processor (host) 30 of the FIG. 2 embodiment, operate according to a set of instructions to perform various operations supporting a user interface system that includes a user input interface and a user output interface provided generally as a display. A user may access the Vehicle Refueling System 500, such as via web access, and which may be for example via “cloud”-hosted application, and/or which may entail wireless connectivity such as via wireless communication network 20 shown. This is accomplished via a user's computing device 516 that may be for example as elsewhere herein shown and/or described, such as for example similar to the exemplary devices providing user interface 40 as shown and described by reference to FIG. 2, and/or according to the examples shown in FIG. 13 (e.g. laptop, notebook, etc.). The user interface/display 520 (and as would also suitably apply to user interface 40 referenced elsewhere herein) may take many different specific forms, generally with one or more windows serving particular purposes within the managed user interface environment. In the example shown in FIG. 13, a window of the display provides a “toolbar” 530 that comprises a number of N features (e.g. graphical features, e.g. identifiable “icons”) that may be selected by a user for further operation according to the respective features' intended uses. An interactive viewing window 540 of the display, and which in some embodiments also provides a user input interface, provides functionality for the operations invoked by selecting one or more of the features. For further illustration, a number of N panes (which may be the same or a different number than the N features) are provided in the interactive viewing window, and to allow different interactive operations to be performed in each pane in relation to the features selected from the toolbar. For example, one or each of multiple user member functions, such as elsewhere herein described, may be represented and invoked by respective icon features in the toolbar, either separately or in parallel—and with respective interactive functionality provided via the various respective panes.

Such further more detailed examples may include the following. An icon is provided for scheduling a refueling in advance of the transaction. Upon selecting this feature to invoke this environment for a member experience, panes may be opened in the interactive viewer window that may include, for example, the following. A first window pane is thereby invoked for scheduling a refueling date/time (e.g. interactive calendar scheduling function, which may be custom developed for this system's purpose or incorporated by other calendaring function commercially available). A second window pane is also provided for indicating location of the vehicle at the planned day/time being scheduled for refueling (e.g. map function or direct text input, e.g. address). The respective panes according to this illustrative example, or others, may also provide for further browsing/scrolling, such as along a grouped number of transactions related to the user, or along various aspects of a given transaction.

It is further appreciated that other functional “selectable” features/icons may also be provided, despite not being specifically shown or described, to implement various operations supported within the respective environment provided. For example, one or more other social networks and/or groups thereunder may be accessed for sourcing members to invite and include under a pre-paid ‘group buy’ provided under certain embodiments the present environment, including via such an icon and related browsing/viewing arrangement.

While the user interface of FIG. 13 provides one example, other specific user interfaces (e.g. display) may be designed and rendered differently for different types of users, e.g. commercial versus private party members (and/or administrator vs. subordinate members grouped under a shared account), and may provide for certain customizability with respect to lay-out and/or features presented to the user within the toolbar (e.g. chosen default features to suit a particular user members' preferred activities, and/or sub-folders such as for example saving certain information related to transactions thereof).

The above examples described by reference to FIG. 13 are considered further beneficial embodiments of this disclosure. However, it is appreciated that various other specific implementations may be made, either in addition or alternative to the examples shown and described, without departing from the intended scope of this disclosure and as relates to other embodiments described herein. For example, other layouts of a screen display related to features/icons, and/or interactive or viewing panes, etc. may be made for a particular purpose and still remain consistent with this disclosure.

It is further contemplated, among the present embodiments, that activities and communications conducted within the environment are managed in a highly secured manner between registered members and fuel delivery providers. In one regard, the locations of user members and their vehicles may be considered confidential, sensitive information. This may be considered even more sensitive regarding corporate, governmental, or military personnel and their vehicles. Moreover, fuel delivery providers may be entrusted with such confidential/sensitive information about the user members and their vehicles' locations (as well as access to those vehicles). According to such considerations, security tokens and/or organization identifications (ID) may be required for certain aspects of operating within the environment. This may apply, for example, to fuel delivery providers in order to become a registered member of the environment. Moreover, certain regulations may be implemented regarding member status and communicational behavior within the environment, with monitoring conducted in order to maintain (or conversely lose) member status and related privileges.

Certain embodiments are herein described by reference to various processors and user interfaces including user input interfaces and user output interfaces such as “displays”. It is to be appreciated that numerous specific embodiments for such interfaces may be appropriately provided to meet a specific need and target environment of users, or subject matter, whether or not specifically shown or described. According to one particularly beneficial system implementation, however, a respective environment embodiment will be implemented via a web-enabled service and related support engines, networked system environments, and interfacing devices. According to a still further beneficial mode of this web service, the environment, system, and methods are configured to support a user interface (UI) via a mobile computing device with a touch screen and by providing a UI application or ‘app’ that may be opened for interactive use by a touch icon providing indicia for the respective environment and related service and/or hosted operations.

Such mobile computing devices can include, for example, a multi-functional computing device for cellular telephony/messaging (e.g., feature phone or smart phone), a tablet device, an ultra-mobile computing device, or a wearable computing device with a form factor of a wearable accessory device (e.g., smart watch or bracelet, glass wear integrated with a computing device, etc.).

One or more embodiments described herein provide that methods, techniques and actions performed by a computing device are performed programmatically, or as a computer-implemented method. Programmatically means through the use of code or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines herein shown or described by reference to the figures provide examples of computer processing resources and computer-readable mediums on which instructions for implementing embodiments of the disclosure can be carried and/or executed. In particular, the numerous machines shown and/or described under certain embodiments include one or more computer processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices), magnetic memory, and detachable ‘plug-in’ peripheral memory resources (e.g. ‘jump’ or ‘thumb’ drives, which may be provided for example with USB plug-in compatibility). Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

The various embodiments of this disclosure also include a user interface. In certain embodiments, this may include, for example, a graphical user interface (GUI). The user interface in certain such embodiments can present information to a user, such as for example a particular set of interactive communications around a transaction under the vehicle refueling system environment. The user interface systems may also include user input as well as user output interfaces (such as displays). According to some embodiments, the user interface can be a passive display or an active touch display (e.g., a capacitive or resistive touch screen). Further examples may include, for example, display and rendering platforms such as: “Magic Leap™” (such as described at www.magicleap.com); or “Oculus Rift™” provided by Oculus VR™ (such as described at www.oculus.com); or Google Glass™” provided by Google (such as for example described at www.google.com/glass).

Although illustrative embodiments are described in detail herein with reference to the accompanying Figures, variations to specific embodiments and details are encompassed by this disclosure. It is intended that the scope of embodiments described herein be interpreted broadly, except where expressly limited. In one regard, each feature or embodiment described or shown herein is considered to provide individual beneficial use, without necessarily requiring combination with other embodiments unless expressly limited to only such combination. In another regard, however, it is also contemplated that a particular feature described, either individually or as part of an embodiment, can be combined with other individually described features, or parts of other embodiments—including such combinations that may not be specifically described or shown herein, as apparent to one of ordinary skill based on the totality of this disclosure. Thus, absence of describing such specific combinations does not preclude such combinations from the intended scope that are contemplated and/or may be claimed herein, either specifically for such combination or as included within a broader scope intended to cover such combination among other possible embodiments.

In context of the foregoing, certain aspects, modes, embodiments, features, and variations of the present disclosure are further described in various statements below. It is to be thus appreciated that each such statement should be considered both independently of, but also in various combinations with (even if not expressly described in each such potential combination), other aspects, modes, embodiments, features, and variations elsewhere herein shown and/or described, as would be appreciated by one of ordinary skill based on a review of the totality of this disclosure. Moreover, while certain statements are made herein by reference to various systems and their related components, certain further aspects of this disclosure also contemplate various methods related to those systems, including for performing the various operations provided by the systems described above or elsewhere hereunder this disclosure. Conversely, still further aspects of this disclosure include such various systems, including as may comprise one or more cooperating components, configured to perform one or more of the operations herein described as part of one or methods.

According to one such further aspect of this disclosure, a vehicle refueling system is provided with a vehicle with a fuel reservoir, a fuel level sensor coupled to the fuel reservoir in a configuration that is operable to measure a fuel level in the fuel reservoir, and at least one wireless transmitter in a configuration that is operable to transmit a wireless signal via a wireless communication network when the measured fuel level is below a threshold value.

According to one mode of this aspect, the system further comprises a position locator in a configuration that is operable to identify a geographic location of the vehicle, and the wireless transmitter is also configured to send vehicle location information via the wireless communication network when the measured fuel level is below the threshold value.

According to one embodiment of this mode, the position locator comprises a global positioning system (GPS) sensor configured to at least in part identify the location of the vehicle via a first set of GPS coordinates, and the vehicle location information comprises the set of GPS coordinates.

According to another embodiment of this mode, the vehicle further comprises a fuel reservoir door that is configured to be electronically unlocked based at least in part upon the measured fuel level being below the threshold value.

In another embodiment, the vehicle further comprises an alarm system that is configured to be electronically de-activated based at least in part upon the measured fuel level being below the threshold value and/or upon a wirelessly transmitted signal.

In still another embodiment, the system further comprises a fuel delivery system in a configuration that is operable to receive the wireless signal via the wireless communication network and to deliver fuel to refuel the vehicle at the vehicle location.

It is also appreciated that the vehicle contemplated under this disclosure may include a computing system comprising at least one computer processor in a configuration that is operable according to a set of instructions stored in a computer readable memory to at least in part perform at least one of the following operations: receive diagnostic information comprising at least one of fuel level in the fuel reservoir, as determined at least in part by the fuel sensor, and the vehicle location, as determined at least in part by the position locator; determine the measured fuel level is below the threshold value for the vehicle; control the wireless transmitter to send at least one of the wireless signal and the vehicle location information to the wireless communication network; determine the vehicle location; electronically unlock the fuel reservoir door or the vehicle cabin doors to access a manual unlock lever or button for the fuel tank; electronically deactivate the alarm system; and direct an operation for delivery of the fuel to refuel the vehicle at the vehicle location.

According to one further embodiment, such a computing system further comprises at least a first said computer processor provided in the vehicle; and also a detachable memory resource that comprises the stored first set of instructions and is detachably coupled to the first computer processor system in a configuration that is readable by the first computer processor in order to perform the at least one operation based on the set of instructions.

Further to this embodiment, the fuel delivery system may also comprise at least a second said computer processor also configured to operate according to a set of instructions stored in a computer readable memory and in order to perform at least another one of the operations based on the set of instructions.

Another aspect of this disclosure comprises a method for refueling a vehicle of a user at a location, comprising: measuring a fuel level of the vehicle; and delivering fuel to refuel the vehicle at the location via a fuel delivery system.

According to one mode of this aspect: the user determines and provides to the fuel delivery system a geographic vehicle location address for the vehicle; and the fuel delivery system directs the fuel to be delivered to refuel the vehicle at the vehicle location.

According to another mode, the method further includes: using a positioning system in the vehicle to determine and provide to the fuel delivery system a geographic vehicle location address for the vehicle; and directing, via the fuel delivery system, the fuel to be delivered to refuel the vehicle at the vehicle location.

According to one embodiment of these various modes, the geographic vehicle location address comprises a set of global positioning system (GPS) network coordinates.

In another mode, a user (e.g. vehicle owner) determines and identifies to the fuel delivery system the vehicle to be refueled.

In further modes, the user determines and identifies to the fuel delivery system at least one of: a volume of fuel to be purchased, a brand of the fuel to be delivered, a grade of fuel to be delivered, time and date for the fuel to be delivered, and purchasing information for purchasing the fuel and/or fuel delivery operation associated with the vehicle refueling at the vehicle location.

In still another mode, the method further comprises directing a third person and/or robotic equipment to the location to deliver the fuel to refuel the vehicle at the location.

In yet another mode, the method is performed without participation by the user in the fuel delivery to, or refueling process of, the vehicle at the vehicle location.

In yet still another mode, the method also comprises estimating a delay for the delivery of fuel to the location via the fuel delivery system.

In yet still another mode, the method further comprises paying for the fuel and or delivery for refueling the vehicle at the vehicle location by at least one of cash, credit card, debit card, check, and electronic payment.

In another mode, the user purchases more fuel than the volume of fuel required and delivered to the vehicle for the refueling at the vehicle location, and such that a remaining volume of excess fuel is stored by a third party.

According to one embodiment of this mode, the method further comprises the user locking in a price for the volume of fuel purchased, including the remaining volume of excess fuel.

Another aspect of this disclosure provides a vehicle refueling system, comprising:

at least one computer readable memory resource containing at least one respective computer executable set of instructions;

a first computer processor;

a second computer processor;

wherein the first processor is configured to operate according to a first said set of instructions to retrieve information from a user's vehicle derived from at least one sensor at the vehicle and to transmit the information from the vehicle to the second processing device; and

wherein the second processor is configured to execute a second said set of instructions to determine a user's driving and fuel consumption patterns via the vehicle, and to predict the user's driving and fuel consumption patterns, in order to determine refueling parameters for the vehicle.

According to one mode of this embodiment, at least one of the first and second processors comprises an on-board diagnostic (OBD) computer processor device, and which may be for example (but not necessarily limited to) an OBD II device.

According to another mode, the system is configured to determine the optimal refueling level for the vehicle based on the user's fuel consumption patterns.

According to another mode, the system is configured to determine at least one of a refueling location, a threshold fuel level, and a time for the vehicle refueling operation to be performed.

According to another mode, a set of refueling preferences are provided by the user, and wherein the preferences are compared to the information retrieved from said system in order to determine refueling levels and locations.

Yet another aspect of this disclosure provides a method for executing a plurality of fuel purchase and delivery transactions with multiple users and related to the users' respective vehicles and respective vehicle locations, and comprises: each user purchasing a respective volume of fuel; and delivering the respective volume of fuel to, and refueling, the respective users' vehicles at each said respective vehicle location.

According to one mode of this aspect, the respective users' vehicles, and respective delivery of fuel for refueling said vehicles, are located at parking lots, such that the respective volumes of fuel are delivered to, and the respective users' vehicles are refueled at, such parking lots when the respective users' vehicles are parked.

Another method mode also comprises: transferring possession of the respective users' vehicles from the respective users to a valet; and wherein the respective valet refuels and parks the respective vehicle.

According to one embodiment of this mode, the valet delivers the respective vehicle to the respective user after the refueling operation is performed.

Another aspect of this disclosure provides a system for refueling a user's vehicle at a vehicle location via a fuel delivery vehicle, and comprises:

at least one computer readable memory medium storing a set of instructions;

at least one computer processor configured to read and operate the set of instructions;

a GPS tracking device on the fuel delivery vehicle; and

wherein the computer processor operated according to the set of instructions is configured to perform at least one of the following operations, in response to an input order to deliver fuel to refuel the vehicle at the vehicle location:
estimate fuel delivery delays for delivering the fuel in response to the order, and
determine at least one or more fuel delivery schedules and locations for fulfilling the order.

According to one mode of this aspect, the set of instructions comprises a schedule identifying one or more times available for fuel delivery to the vehicle at the location.

According to another mode, the system further comprises a user interface, and the at least one computer processor operating according to the set of instructions is configured to provide information to the user interface identifying availability of a fuel delivery operation to deliver fuel to such user's vehicle in a determined timeframe.

It is further appreciated that any of the other aspects, modes, embodiments, features, and variations herein described or shown by reference to the figures may also further include: rendering, by use of at least one computer processor operated according to a set of computer instructions stored in a computer readable memory, respective information regarding a vehicle refueling transaction to a user, and/or fuel delivery provider, via a user and/or provider interface system, respectively, comprising a user and/or provider interface display, also respectively.

One further mode of the foregoing also provides such a system or method with a user interface system that comprises a web-enabled interface between a remote computing device and at least one host processor. The remote computing device also comprises a client processor, a display comprising a user input interface, and a client app comprising a first set of instructions stored in the remote computing device. The client processor is also operable to run the client app to communicate with the host processor, render information received from the host processor on the display, and receive user inputs via the user input interface and perform operations according to said user inputs. The at least one host processor is also configured to operate according to a second set of instructions in order to communicate and cooperate with the remote computing device in performing one or more operations.

According to one embodiment of this mode, at least one of the user and/or provider interface systems comprises a mobile computing device.

According to one further feature also contemplated under this embodiment, the mobile computing device is connected to a communication network via a wireless connection.

According to another feature, the mobile computing device comprises a touch screen that comprises the display and the user and/or provider input interface. Still further to this feature, the user and/or provider interface system may comprise an application that is activated via a touch icon presented on the touch screen.

Another aspect of this disclosure provides a vehicle refueling system, comprising a vehicle, a refueling vehicle (VH), and a co-location processor system (CPS).

The vehicle according to this aspect includes a fuel reservoir and a fuel port providing access to the fuel reservoir for refueling, and at least one of (i) an electronically controlled alarm and (ii) an electronically or manually controlled fuel lock to control access to the fuel reservoir via the fuel port. It also includes a vehicle processor system (VPS) comprising at least one vehicle computer processor provided with the vehicle and configured to process a set of VPS operating instructions to operate a controller electronically coupled to at least one of the alarm and fuel lock in a configuration that is operable to send at least one of (a) a deactivate command to deactivate the alarm, and (b) an unlock command to unlock the fuel lock or the vehicle doors, in response to at least one of a deactivate instruction and an unlock instruction received by the controller, respectively. It also includes at least one vehicle antenna electronically coupled to the VPS and in a configuration that is operable to communicate wirelessly via the VPS over a wireless communication network.

The refueling vehicle (RV) according to this aspect has an RV fuel reservoir containing a volume of fuel and a fuel transfer coupler configured to transfer the volume of fuel from the RV fuel reservoir to the fuel reservoir of the vehicle via the fuel port.Further to this aspect, at least one of the deactivate and unlock instructions is generated and communicated to the controller based at least in part on at least one of a scheduled refueling of the vehicle by the RV or a proximate co-location between the vehicle and the RV within a pre-determined range. The controller transmits at least one of the deactivate and unlock commands, respectively, in response to at least one of the deactivate and unlock instructions received, and such that at least one of the alarm is wirelessly deactivated and the fuel lock is wirelessly unlocked to facilitate refueling of the vehicle by the RV without triggering the alarm and with open access to the fuel reservoir via the fuel port.

According to one mode of this aspect, the pre-determined range comprises a range sufficient for fuel transfer from the RV to the vehicle via the fuel transfer coupler.

According to another mode, a co-location processor system (CPS) is provided with at least one CPS computer processor coupled to the wireless communication network via at least one CPS wireless antenna and is configured to process a set of CPS operating instructions to determine the proximate co-location of the vehicle and RV.

According to one embodiment of this mode, the CPS further comprises a user interface configured to receive a user input that identifies the proximate co-location between the vehicle and RV.

According to another embodiment of this mode, the CPS further comprises a vehicle-RV wireless connection between the vehicle antenna and at least one RV antenna coupled to an RV processor system (RVPS) comprising at least one RV computer processor that processes a set of RVPS operating instructions and is provided with the RV. The CPS is further configured to receive at least one input in response to the at least one wireless location signal transmitted across the vehicle-RV wireless connection and to determine the co-location based at least in part upon the input.

According to one beneficial feature further contemplated under this embodiment: the at least one wireless location signal comprises a feature that represents a distance between the respective vehicle and RV antennas; and the CPS is configured to process the CPS operating instructions to determine the proximate co-location based upon the feature. Such signal feature may, for example, comprise a power level of the at least one wireless location signal received at one of said respective vehicle and RV antennas following transmission from the other respective antenna.

According to another beneficial feature also contemplated under this embodiment, the vehicle-RV wireless connection has a limited distance range for a successful reception of the wireless location signal transmission and such that the co-location determination is based at least in part on the reception.

In yet another embodiment, the CPS comprises at least one of the VPS and RVPS.

According to another embodiment of the CPS mode, the system further comprises an RV processing system (RVPS) comprising at least one RV computer processor coupled to at least one RV antenna and configured to process a set of RV operating instructions to communicate across the wireless communication network via the RV antenna. Further to this mode, at least one of the VPS and RVPS is configured to transmit a wireless signal containing a code that uniquely identifies the respective vehicle or RV and is recognized by the CPS with an authorized refueling of the vehicle by the RV together with the co-location determination. At least one of the deactivate and unlock instructions is generated in response to both the co-location determination and code recognition.

According to still another embodiment of this mode, the CPS comprises a vehicle position sensor wirelessly coupled to a global positioning system (GPS) to identify a first geographic location of the vehicle via a first set of GPS coordinates, and also an RV position sensor wirelessly coupled to the GPS to identify a second geographic location of the RV via a second set of GPS coordinates. The CPS is further configured to receive and calculate the distance between the first and second sets of GPS coordinates, and to thereby determine the co-location of the vehicle and RV when the calculated distance meets a distance threshold.

According to yet another embodiment of this mode, the CPS comprises at least one remote processing system (RPS) comprising at least one RPS computer processor that is remotely located separately apart from the vehicle, and is electronically coupled to at least one RPS antenna. The RPS is also configured to process a set of RPS operating instructions to communicate wirelessly with the VPS via the wireless communication network between the remote antenna and the vehicle antenna.

In yet another embodiment of this mode, at least one remote processing system (RPS) is provided and that comprises at least one remote computer processor that is remotely located separately apart from the vehicle, and is electronically coupled to at least one remote antenna. The RPS is configured to process a set of RPS operating instructions to communicate wirelessly with the VPS via the wireless communication network between the remote antenna and the vehicle antenna. Further to this mode, at least one of the deactivation and unlock instructions is generated via a wireless instruction signal from the RPS to the VPS over the wireless communication network in response to the co-location determination.

According to certain further features also contemplated under this embodiment, the CPS further comprises at least in part, and performs at least in part the operations for, the RPS; or the RPS comprises at least in part, and performs at least in part the operations of, the CPS.

In still another mode of the present aspect, the system further comprises: a fuel level sensor coupled to the fuel reservoir in a configuration that is operable to measure a fuel level in the fuel reservoir, and also coupled to the VPS; and at least one wireless vehicle transmitter electronically coupled to the controller and also to the vehicle antenna. In response to a fuel level value received by the VPS via the fuel level sensor, the controller is configured to send a fuel level command to control the vehicle transmitter to transmit a wireless fuel level signal via the vehicle antenna and over the wireless communication network, and which provides information related to a measured fuel level in the fuel reservoir.

According to one embodiment of this mode, the controller is configured to send the fuel level command only when the fuel level is below a threshold value.

According to another embodiment, a remote processing system (RPS) comprising at least one RPS computer processor is provided remotely located separately apart from the vehicle, and is electronically coupled to at least one RPS antenna. The RPS is configured to process a set of RPS operating instructions to communicate wirelessly with the VPS via the wireless communication network between the RPS antenna and the vehicle antenna, to receive the wireless fuel level signal, and to transmit a dispatch signal in response to receiving the fuel level signal to dispatch the RV to co-locate with the vehicle for vehicle refueling.

According to another mode of the present aspect, a vehicle position locator is also coupled to the vehicle and configured to identify a geographic location of the vehicle. The controller is also configured to transmit a vehicle location signal providing the vehicle location via the vehicle transmitter and over the wireless communication network when the measured fuel level is below the threshold value. A remote processing system (RPS) comprising at least one RPS computer processor is also provided remotely located separately apart from the vehicle, and is electronically coupled to at least one RPS antenna. The RPS is configured to process a set of RPS operating instructions to communicate wirelessly with the VPS via the wireless communication network between the RPS antenna and the vehicle antenna, to receive the vehicle location signal, and to dispatch the RV to co-locate with the vehicle in response to the vehicle location signal.

In yet another mode, the vehicle further comprises a door that is adjustable between a closed configuration, which prevents user access to the fuel port for the fuel reservoir, and an open configuration, which allows user access to the fuel port. The fuel lock according to this mode is adjustable between a locked condition, wherein the door is locked in the closed configuration that prevents access to the fuel reservoir via the fuel port, and an unlocked condition, wherein the door is allowed to be opened by a user to the open configuration and to thereby allow access to the fuel reservoir via the fuel port.

According to one embodiment of this mode, the door comprises a fuel door that covers the fuel port to prevent user access thereto when locked in the closed configuration, and that exposes the uncovered fuel port to allow user access thereto in the open configuration.

According to another embodiment, the vehicle further comprises a fuel door that covers the fuel port to prevent user access thereto when locked in a closed configuration, and that exposes the uncovered fuel port to allow user access thereto when in an open configuration. A fuel door lock is coupled to the fuel door and that is adjustable between a locked condition that locks the fuel door in the closed configuration and an unlocked condition that allows the fuel door to be adjusted to the open configuration. An internal cabin of the vehicle contains a fuel door actuator that actuates the fuel door lock to its respective unlocked condition in response to a user input within the internal cabin. The door according to this embodiment thus comprises a cabin door that is adjustable between a closed configuration that prevents user access to the internal cabin and an open configuration that exposes and allows user access to the internal cabin and fuel door actuator provided therein.

In yet another embodiment wherein the door comprises a cabin door or fuel door itself, the fuel lock is returned to the locked condition by manually re-closing the respective door from the open configuration to the closed configuration, respectively.

In another mode of the present aspect, the controller is further operable to send at least one of an activate command to activate the alarm, and a lock command to lock the fuel lock (which again may control, for example, at least one of a cabin door for controlled access to a fuel door actuator, and a fuel door directly covering the fuel port), in response to at least one of an activate instruction and an unlock instruction received by the controller, respectively. At least one of the activate and lock instructions is communicated to the controller in response to a completed refueling of the vehicle by the RV. The controller is also further configured to transmit at least one of the activate and lock commands, respectively, in response to at least one of the activate and lock instructions received, and such that at least one of the alarm is wirelessly activated and the fuel lock is wirelessly locked following the completed refueling.

In one embodiment of this mode, a fuel level sensor is also coupled to the fuel reservoir in a configuration that is operable to measure a fuel level in the fuel reservoir, and also coupled to the VPS. At least one of the activate and lock instructions is generated to the controller in response to the measured fuel level reaching a threshold value.

In another embodiment of this mode, a remote processing system (RPS) comprising at least one RPS computer processor is provided at a separate location apart from the vehicle, and is coupled to an RPS antenna. The RPS is configured to process a set of RPS operating instructions to receive user inputs via a user interface and to communicate with the VPS via the wireless communication network between the RPS antenna and the vehicle antenna. At least one of the activate and lock instructions is generated in response to a wireless completion signal transmitted via the RPS antenna and received via the wireless communication network at the vehicle antenna in response to a user input via the user interface indicating refueling completion.

In another embodiment of this mode, an RV sensor is coupled to the RV and configured to sense at least one of a location of the RV and an event associated with a completed refueling of the vehicle. A remote processing system (RPS) comprising at least one remote computer processor is provided at a separate location apart from the vehicle and coupled to at least one RPS antenna and in communication with the RV sensor. The RPS is configured to process a set of RCP operating instructions to communicate wirelessly with the VPS, via the wireless communication network between the RPS antenna and the vehicle antenna, and to transmit a completion signal to the VPS via the wireless communication network in response to at least one of the RV location moving away from the co-location with the vehicle and the sensed event. At least one of the activate and lock instructions is generated in response to the wireless completion signal received by the VPS.

Certain further sensed events contemplated under this embodiment may include, for example but without limitation: a fume sensor associated with a fuel nozzle of the fuel coupler sensing completion of the refueling based on fuel fumes at the fuel port; returning the fuel coupler to a retainer on the RV following completed refueling; and a user input to a user interface in communication with the RPS and indicating refueling completion.

According to still another mode of the current aspect, the VPS comprises an on-board diagnostics (OBD) system comprising at least one OBD computer processor and an OBD port electronically coupled to the OBD computer processor. The VPS also comprises a peripheral device that is detachably coupled to the OBD port and comprises a computer readable memory that is readable by the OBD computer processor and stores at least a portion of at least one of the VPS and CPS operating instructions for performing one or more of the various operations and methods herein disclosed.

In a further embodiment of this mode, the peripheral device comprises at least one of: at least a portion of the VPS controller, and the VPS antenna.

Another aspect of this disclosure comprises method for using a refueling vehicle (RV) to refuel a vehicle at a vehicle location, wherein the vehicle comprises at least one of (i) an alarm, and (ii) a fuel lock controlling access to a fuel reservoir via a fuel port of the vehicle, that is electronically controllable via commands from a controller of a vehicle processing system (VPS) in the vehicle and comprising at least one computer processor configured to process a set of VPS operating instructions.

The method according to this aspect further comprises performing at least one of: scheduling a refueling of the vehicle via the RV, and determining a proximate co-location of the vehicle and the RV within a predetermined range. At least one computer processor is also operated according to a set of instructions to generate at least one of a deactivate instruction and an unlock instruction as an input to the controller, based at least in part on at least one of the scheduled refueling and the co-location determination. The controller is also operated, in response to at least one of the deactivate and unlock instructions received, to transmit at least one of a deactivate command to deactivate the alarm and an unlock command to unlock the fuel lock, respectively, and to thereby provide user access for refueling of the vehicle via the co-located RV.

According to one mode of this aspect, the method further comprises using a co-location processor system (CPS) comprising at least one CPS computer processor coupled to a wireless communication network via at least one CPS wireless antenna and configured to process a set of CPS operating instructions to receive at least one location input via a wireless communication network and associated with a location for at least one of the vehicle and the RV, and to determine the proximate co-location between the vehicle and RV based on the at least one location input.

Further modes, embodiments, features, and variations of the methods described above are also contemplated, such as for example as would be apparent to one of ordinary skill for performing the various methods contemplated for using the systems (and related components) described above.

Although illustrative embodiments have been described in detail herein, including in some regards by reference to the accompanying drawings, variations to such specific embodiments and details as would be apparent to one of ordinary skill are encompassed by this disclosure despite not being specifically shown or described. It is intended that the scope of embodiments described herein be defined by claims and their equivalents. However, the right is preserved and not waived to claim various aspects, modes, embodiments, or features or variations disclosed herein despite such being absent from the originally or later filed claims. Furthermore, it is contemplated that a particular feature described, either individually or as part of an embodiment, can be combined with other individually described features or parts of other embodiments. Such further combinations may be claimed based on this disclosure despite not being expressly shown or described or included in the originally filed claims.

What is claimed is:

1. A vehicle refueling system, comprising:
a vehicle with:
a fuel reservoir,
a fuel port providing access to the fuel reservoir for refueling,
at least one of (i) an electronically controlled alarm, and (ii) an electronically controlled fuel lock configured to control user access to the fuel reservoir via the fuel port,
a vehicle processor system (VPS) comprising at least one vehicle computer processor provided with the vehicle and configured to process a set of VPS operating instructions to operate a controller electronically coupled to the at least one of the alarm and fuel lock in a configuration that is operable to send at least one of (a) a deactivate command for deactivating the alarm, and (b) an unlock command for unlocking the fuel lock, in response to at least one of a deactivate instruction and an unlock instruction received by the controller, respectively, and
at least one vehicle antenna electronically coupled to the VPS and in a configuration that is operable to communicate wirelessly via the VPS over a wireless communication network;
a refuel vehicle (RV) with an RV fuel reservoir containing fuel and a fuel transfer coupler configured to transfer the fuel from the RV fuel reservoir to the fuel reservoir of the vehicle via the fuel port;
wherein at least one of the deactivate and unlock instructions is generated and communicated to the controller at least in part based on a scheduled refueling of the vehicle by the RV or a proximate co-location between the vehicle and the RV within a pre-determined range; and
whereby the controller transmits at least one of the deactivate and unlock commands, respectively, in response to at least one of the deactivate and unlock instructions being correspondingly received, and such that at least one of (i) the alarm is wirelessly deactivated and (ii) the fuel lock is wirelessly unlocked to facilitate refueling of the vehicle by the co-located RV without triggering the alarm and with open access to the fuel reservoir via the fuel port.

2. The system of claim 1, further comprising:
a co-location processor system (CPS) comprising at least one CPS computer processor coupled to the wireless communication network via at least one CPS wireless antenna and configured to process a set of CPS operating instructions to determine the proximate co-location of the vehicle.

3. The system of claim 2, wherein the CPS comprises:
a user interface configured to receive a user input that identifies the proximate co-location between the vehicle and RV.

4. The system of claim 2, wherein:
the CPS further comprises a vehicle-RV wireless connection between the vehicle antenna and at least one RV antenna coupled to an RV processor system (RVPS) comprising at least one RV computer processor that processes a set of RVPS operating instructions and is provided with the RV; and
the CPS is further configured to receive at least one input in response to the at least one wireless location signal transmitted across the vehicle-RV wireless connection and to determine the co-location based at least in part upon the input.

5. The system of claim 4, wherein:
the at least one wireless location signal comprises a feature that represents a distance between the respective vehicle and RV antennas; and
the CPS is configured to process the CPS operating instructions to determine the proximate co-location based upon the feature.

6. The system of claim 5, wherein said feature comprises a power level of the at least one wireless location signal received at one of said respective vehicle and RV antennas following transmission from the other respective antenna.

7. The system of claim 4, wherein the vehicle-RV wireless connection has a limited distance range for a successful reception of the wireless location signal transmission and such that the co-location determination is based at least in part on the reception.

8. The system of claim 4, wherein the CPS comprises at least one of the VPS and RVPS.

9. The system of claim 2, further comprising:
an RV processing system (RVPS) comprising at least one RV computer processor coupled to at least one RV antenna and configured to process a set of RV operating instructions to communicate across the wireless communication network via the RV antenna;
wherein at least one of the VPS and RVPS is configured to transmit a wireless signal containing a code that uniquely identifies the respective vehicle or RV and is recognized by the CPS with an authorized refueling of the vehicle by the RV together with the co-location determination; and
wherein at least one of the deactivate and unlock instructions is generated in response to both the co-location determination and code recognition.

10. The system of claim 2, wherein the CPS comprises:
a vehicle position sensor wirelessly coupled to a global positioning system (GPS) to identify a first geographic location of the vehicle via a first set of GPS coordinates;
an RV position sensor wirelessly coupled to the GPS to identify a second geographic location of the RV via a second set of GPS coordinates; and
wherein the CPS is further configured to receive and calculate the distance between the first and second sets of GPS coordinates, and to thereby determine the co-location of the vehicle and RV when the calculated distance meets a distance threshold.

11. The system of claim 2, wherein the CPS comprises:
at least one remote processing system (RPS) comprising at least one RPS computer processor that is remotely located separately apart from the vehicle, and is electronically coupled to at least one RPS antenna, and that is configured to process a set of RPS operating instructions to communicate wirelessly with the VPS via the wireless communication network between the remote antenna and the vehicle antenna.

12. The system of claim 2, further comprising:
at least one remote processing system (RPS) comprising at least one remote computer processor that is remotely located separately apart from the vehicle, and is electronically coupled to at least one remote antenna, and that is configured to process a set of RPS operating instructions to communicate wirelessly with the VPS via the wireless communication network between the remote antenna and the vehicle antenna; and
wherein at least one of the deactivation and unlock instructions is generated via a wireless instruction signal from the RPS to the VPS over the wireless communication network in response to the co-location determination.

13. The system of claim 12, wherein the CPS further comprises the RPS.

14. The system of claim 1, further comprising:
a fuel level sensor coupled to the fuel reservoir in a configuration that is operable to measure a fuel level in the fuel reservoir, and also coupled to the VPS;
at least one wireless vehicle transmitter electronically coupled to the controller and also to the vehicle antenna; and
wherein, in response to a fuel level value received by the VPS via the fuel level sensor, the controller is configured to send a fuel level command to control the vehicle transmitter to transmit a wireless fuel level signal via the vehicle antenna and over the wireless communication network, and which provides information related to a measured fuel level in the fuel reservoir.

15. The system of claim 14, wherein the controller is configured to send the fuel level command only when the fuel level is below a threshold value.

16. The system of claim 14, further comprising:
a remote processing system (RPS) comprising at least one RPS computer processor that is remotely located separately apart from the vehicle, and is electronically coupled to at least one RPS antenna, and that is configured to process a set of RPS operating instructions to communicate wirelessly with the VPS via the wireless communication network between the RPS antenna and the vehicle antenna, to receive the wireless fuel level signal, and to transmit a dispatch signal in response to receiving the fuel level signal to dispatch the RV to co-locate with the vehicle for vehicle refueling.

17. The system of claim 1, further comprising:
a vehicle position locator coupled to the vehicle and configured to identify a geographic location of the vehicle;
wherein the controller is also configured to transmit a vehicle location signal providing the vehicle location via the vehicle transmitter and over the wireless communication network when the measured fuel level is below the threshold value; and
a remote processing system (RPS) comprising at least one RPS computer processor that is remotely located separately apart from the vehicle, and is electronically coupled to at least one RPS antenna, and that is configured to process a set of RPS operating instructions to communicate wirelessly with the VPS via the wireless communication network between the RPS antenna and the vehicle antenna, to receive the vehicle location signal, and to dispatch the RV to co-locate with the vehicle in response to the vehicle location signal.

18. The system of claim 1, wherein:
the vehicle further comprises a door that is adjustable between a closed configuration, which prevents user access to the fuel port for the fuel reservoir, and an open configuration, which allows user access to the fuel port; and
the fuel lock is adjustable between a locked condition, wherein the door is locked in the closed configuration that prevents access to the fuel reservoir via the fuel port, and an unlocked condition, wherein the door is allowed to be opened by a user to the open configuration and to thereby allow access to the fuel reservoir via the fuel port.

19. The system of claim 18, wherein:
the door comprises a fuel door that covers the fuel port to prevent user access thereto when locked in the closed configuration, and that exposes the uncovered fuel port to allow user access thereto in the open configuration.

20. The system of claim 18, wherein the vehicle further comprises:
a fuel door that covers the fuel port to prevent user access thereto when locked in a closed configuration, and that exposes the uncovered fuel port to allow user access thereto when in an open configuration;
a fuel door lock coupled to the fuel door and that is adjustable between a locked condition that locks the fuel door in the closed configuration and an unlocked condition that allows the fuel door to be adjusted to the open configuration;
an internal cabin with a fuel door actuator that actuates the fuel door lock to the unlocked condition in response to a user input within the internal cabin; and
wherein the door comprises a cabin door that is adjustable between a closed configuration that prevents user access to the internal cabin and an open configuration that exposes and allows user access to the internal cabin and fuel door actuator provided therein.

21. The system of claim 18, wherein the fuel lock is returned to the locked condition by manually re-closing the open door from the unlocked condition.

22. The system of claim 1, wherein:
the controller is further operable to send at least one of an activate command to activate the alarm, and a lock command to lock the fuel lock, in response to at least one of an activate instruction and an unlock instruction received by the controller, respectively;
wherein at least one of the activate and lock instructions is communicated to the controller in response to a completed refueling of the vehicle by the RV; and
wherein the controller is further configured to transmit at least one of the activate and lock commands, respectively, in response to at least one of the activate and lock instructions received, and such that at least one of the alarm is wirelessly activated and the fuel lock is wirelessly locked following the completed refueling.

23. The system of claim 22, further comprising:
a fuel level sensor coupled to the fuel reservoir in a configuration that is operable to measure a fuel level in the fuel reservoir, and also coupled to the VPS; and
wherein at least one of the activate and lock instructions is generated to the controller in response to the measured fuel level reaching a threshold value.

24. The system of claim 22, further comprising:
a remote processing system (RPS) comprising at least one RPS computer processor that is located separately apart from the vehicle, and coupled to an RPS antenna, and configured to process a set of RPS operating instructions to receive user inputs via a user interface and to communicate with the VPS via the wireless communication network between the RPS antenna and the vehicle antenna; and
wherein at least one of the activate and lock instructions is generated in response to a wireless completion signal transmitted via the RPS antenna and received via the wireless communication network at the vehicle antenna in response to a user input via the user interface indicating refueling completion.

25. The system of claim 22, further comprising:
an RV sensor coupled to the RV and configured to sense at least one of a location of the RV and an event associated with a completed refueling of the vehicle;
a remote processing system (RPS) comprising at least one remote computer processor located separately apart from the vehicle and coupled to at least one RPS antenna and in communication with the RV sensor, and configured to process a set of RCP operating instructions to communicate wirelessly with the VPS, via the wireless communication network between the RPS antenna and the vehicle antenna, and to transmit a completion signal to the VPS via the wireless communication network in response to at least one of the RV location moving away from the co-location with the vehicle and the sensed event; and
wherein at least one of the activate and lock instructions is generated in response to the wireless completion signal received by the VPS.

26. The system of claim 1, wherein the VPS comprises:
an on-board diagnostics (OBD) system comprising at least one OBD computer processor and an OBD port electronically coupled to the OBD computer processor; and
a peripheral device that is detachably coupled to the OBD port and comprises a computer readable memory that is readable by the OBD computer processor and stores at least a portion of at least one of the VPS and CPS operating instructions.

27. The system of claim 26, wherein the peripheral device comprises at least one of: at least a portion of the VPS controller, and the VPS antenna.

28. A method for using a refueling vehicle (RV) to refuel a vehicle at a vehicle location, wherein the vehicle comprises at least one of (i) an alarm, and (ii) a fuel lock controlling access to a fuel reservoir via a fuel port of the vehicle, that is electronically controllable via commands from a controller of a vehicle processing system (VPS) in the vehicle and comprising at least one computer processor configured to process a set of VPS operating instructions, comprising:
at least one of scheduling a refueling of the vehicle via the RV and determining a proximate co-location of the vehicle and the RV within a predetermined range;
operating at least one computer processor according to a set of instructions to generate at least one of a deactivate instruction and an unlock instruction as an input to the controller, based at least in part on at least one of the scheduled refueling and the co-location determination; and
operating the controller, in response to at least one of the deactivate and unlock instructions received, to transmit at least one of a corresponding deactivate command to deactivate the alarm and a corresponding unlock command to unlock the fuel lock, respectively, and to thereby provide user access for refueling of the vehicle via the co-located RV.

29. The method of claim 28, further comprising:
using a co-location processor system (CPS) comprising at least one CPS computer processor coupled to a wireless communication network via at least one CPS wireless antenna and configured to process a set of CPS operating instructions to receive at least one location input via a wireless communication network and associated with a location for at least one of the vehicle and the RV, and to determine the proximate co-location between the vehicle and RV based on the at least one location input.
